(19) United States
(12) Patent Application Publication
(10) Pub. No.: US 2026/0240185 A1
(43) Pub. Date: Aug. 20, 2026

(54) IMITATION CHEESE, METHOD FOR PRODUCING SAME, AND FOOD PRODUCT USING IMITATION CHEESE

(71) Applicant: ADEKA CORPORATION, Tokyo (JP)

(72) Inventors: Kazumasa ABE, Tokyo (JP); Satoru OZAKI, Tokyo (JP); Yoshiyuki FUKUGAMA, Tokyo (JP); Kazuhiro SASAKI, Tokyo (JP)

(21) Appl. No.: 18/874,444

(22) PCT Filed: Jun. 26, 2023
(86) PCT No.: PCT/JP2023/023453

§ 371 Date: Dec. 12, 2024

(30) Foreign Application Priority Data
Jun. 29, 2022 (JP) 2022-104616

(51) Int. Cl. A23C 20/02; A23L 25/00

(52) U.S. Cl. CPC A23C 20/025; A23L 25/30

(57) ABSTRACT

Provided is an imitation cheese from which any odd taste is difficult to perceive, that has a favorable texture without a rough texture, that is capable of maintaining smooth physical properties without generation of lumps over the course of multiple days, that has high emulsion stability, and that does not undergo oil-water separation. An imitation cheese includes an oil-in-water emulsion composition containing a nut- and seed-derived material and an aging-resistant starch, the nut- and seed-derived material having a protein content of 15 to 95% by mass, the oil-in-water emulsion composition having a pH of 3.5 to 6.0. The imitation cheese has a protein content of 0.2 to 10.0% by mass.

### TECHNICAL FIELD

The present invention relates to an imitation cheese and its production method, and a food product using the imitation cheese.

### BACKGROUND ART

Cheese is one type of dairy products produced by a process such as coagulation, fermentation, maturation, and the like using a raw material derived from milk from cow, water buffalo, sheep, goat, yak, or the like.

Cheese produced using a raw material derived from milk cannot be eaten by those who are commonly referred to as vegetarians and are easily affected by a sudden rise in the price of milk. There is thus a demand for an imitation cheese that has a taste and a texture similar to cheese without using a milk-derived raw material.

On the other hand, of cheeses, a cream cheese has a lower degree of stringiness, but a more favorable soft texture and smooth physical properties than other cheeses. Thus, a cream cheese is eaten not only as it is, but also after application to a bread or the like, and a cream cheese is widely used as raw materials for confectionery such as cheesecake and tiramisu, and dipping sauces. There is a demand for an imitation cheese that has cream cheese-like smooth physical properties in addition to a taste and a texture similar to those of a cream cheese and that can be used in the same applications as those of a cream cheese.

However, the taste, texture, and smooth physical properties of a cream cheese largely depend on a milk protein contained in the cream cheese. Therefore, when a milk-derived raw material is not used, it is difficult to obtain these characteristics.

Studies on imitation cheeses that meet the required characteristics of a cream cheese using plant-derived raw materials instead of milk-derived raw materials have been progressing. Imitation cheeses that use, among plant-derived raw materials, particularly raw materials derived from beans, which are rich in protein, as a main component have been reported.

For example, Patent Literature 1 discloses a method for producing a plant cream cheese-like food product in which a protein coagulating agent and starches are mixed in a soybean protein solution adjusted to a temperature of 40 to 80° C. and afterwards the mixture is immediately put into a container, heated and coagulated, and then frozen in an atmosphere of −20° C. or lower, resulting in denaturation.

Patent Literature 2 discloses a gelled mung bean protein composition containing a mung bean protein and an alkali metal ion, wherein the gelled mung bean protein composition contains the alkali metal ion at a concentration of 50 mM or more relative to the entire amount of the gelled mung bean protein composition.

Patent Literature 3 discloses a cream cheese-like food product that is produced by acidifying an emulsion containing a soybean protein hydrolysate and a fat and oil, the soybean protein hydrolysate being obtained by a treatment with a protease in a neutral or alkaline range.

Patent Literature 4 discloses a method for producing a cheese-like food product including the steps of: preparing soybean milk in which 60% or more of soluble saccharide fraction is removed from raw soybeans; adding saccharides and a lactic acid bacteria to the soybean milk and carrying out lactic acid fermentation; subjecting curds produced by the lactic acid fermentation to solid-liquid separation; and molding, fermenting, and maturating the curd after the solid-liquid separation.

When a bean-derived raw material is mainly used, a taste peculiar to the bean is imparted to an imitation cheese. Consequently, in recent years, there has been a drive to study imitation cheeses that mainly use raw materials derived from nuts and seeds, which serve as raw materials derived from plants other than beans.

For example, Patent Literature 5 discloses a plant food product similar to a cream cheese, including: crushed nuts, preferably in the form of a puree, with the addition of at least a plant fat, at least one source of starch, a natural acidifying ingredient, and water, wherein the plant food product contains no additives and has a specific median particle diameter.

Patent Literature 6 discloses a method for producing a plant cheese-like food product including: applying a nuclease to a raw material containing a plant protein, and acidifying the raw material. Also described herein is a method for producing a plant cheese-like food product in which a raw material containing a plant protein is derived from seeds.

Patent Literature 7 discloses a method including steps of: preparing an emulsion containing a protein derived from a plant source and a fat; inducing the emulsion to form a gel by enzymatic cross-linking of the protein or denaturation of the protein; and producing a cheese replica from the gel. Also described herein is described the method in which the plant source is a nut and the method in which the emulsion is a non-dairy milk.

### RELATED ART REFERENCE

### Patent Literature

Patent Literature 1: International Publication No. 2015/166686
Patent Literature 2: International Publication No. 2014/156549
Patent Literature 3: International Publication No. 2006/135089
Patent Literature 4: Japanese Patent Application Laid-Open No. H7-236417 A
Patent Literature 5: Japanese Patent Application Laid-Open No. 2022-027689
Patent Literature 6: International Publication No. 2021/193892
Patent Literature 7: Japanese Patent Application Laid-Open No. 2018-064558

### SUMMARY OF INVENTION

### Problem to be Solved by the Invention

The imitation cheeses conventionally studied and disclosed have the following problems.

When a bean-derived protein is mainly used as in Patent Literatures 1 and 2, the obtained imitation cheese has problems in that the texture is rough and smooth physical properties are not achieved. The bean-derived protein has a decreased emulsification-maintaining force (hereinafter referred to as emulsion stability) at an acidic pH region. Therefore, when the pH of the imitation cheese is adjusted to a pH similar to a cream cheese, there is a problem in that oil-water separation occurs or physical properties deteriorate. When an enzyme-treated bean-derived raw material is mainly used as shown in Patent Literature 3, there are problems in that the process of producing an imitation cheese is complicated and if the enzyme is not completely inactivated, the texture and physical properties of the imitation cheese deteriorate with time. Patent Literature 4 has a problem in that a production process is complicated since a soybean milk that satisfies a specific condition is required and lactic acid fermentation is required. When a soybean milk is mainly used as a plant-derived raw material, occurrence of a rough texture is suppressed as compared with a case of mainly using a bean-derived protein, or the like. However, there is a problem in that the shape retention of an imitation cheese is low and physical properties deteriorate since most of the content of the soybean milk is water. In addition, an imitation cheese mainly using a bean-derived raw material has a taste peculiar to the bean as in Patent Literatures 1 to 4, and therefore the imitation cheese has a problem in that the taste is likely to be inferior.

As compared with an imitation cheese mainly using a bean-derived raw material, an imitation cheese mainly using a nut- and seed-derived raw material is less likely to be imparted an odd taste caused by a plant-derived raw material, similarly to those in Patent Literatures 5 to 7, and therefore the taste tends to be improved. However, in order to obtain cream cheese-like taste and texture and smooth physical properties, further studies are required.

After storage at a temperature that is a normal temperature (20 to 25° C.) or lower for a fixed period, imitation cheeses may be eaten as they are or may be used as one of the raw materials for food and drink. Although the imitation cheeses have smooth physical properties obtained immediately after production, small lumps may be generated in the imitation cheeses over the course of multiple days during storage, resulting in deterioration of the texture and the smooth physical properties.

The conventionally known imitation cheeses as disclosed in Patent Literatures 1 to 7 may also have such problems. Therefore, there is a need for an imitation cheese in which smooth physical properties obtained immediately after production can be maintained for an extended period of time.

Accordingly, an object of the present invention is to provide an imitation cheese that satisfies all the following items 1) to 4):
1) any odd taste from the imitation cheese is difficult to perceive;
2) the imitation cheese has a favorable texture without a rough texture;
3) the imitation cheese is capable of maintaining smooth physical properties without generation of lumps over the course of multiple days; and
4) the imitation cheese has high emulsion stability and does not undergo oil-water separation.

### Means for Solving Problem

The inventors of the present invention intensively conducted research for solving the above-mentioned problems. As a result, they found that the problems described above can be solved by an imitation cheese having the following configuration and thus achieved the present invention.

Namely the present invention has the following configuration.

[1] An imitation cheese comprising an oil-in-water emulsion composition containing a nut- and seed-derived material and an aging-resistant starch, the nut- and seed-derived material having a protein content of 15 to 95% by mass, the oil-in-water emulsion composition having a pH of 3.5 to 6.0, and the imitation cheese having a protein content of 0.2 to 10.0% by mass.

[2] The imitation cheese according to [1], wherein an amount of fat and oil of the nut- and seed-derived material is 40% by mass or less.

[3] The imitation cheese according to [1] or [2], wherein an amount of fat and oil of the nut- and seed-derived material is 2.0 parts by mass or less relative to 1 part by mass of the protein content of the nut- and seed-derived material.

[4] The imitation cheese according to [1] or [2], wherein the nut- and seed-derived material is contained in an amount of 0.1 to 10% by mass in the oil-in-water emulsion composition.

[5] The imitation cheese according to [3], wherein the nut- and seed-derived material is contained in an amount of 0.1 to 10% by mass in the oil-in-water emulsion composition.

[6] The imitation cheese according to [1] or [2], wherein the aging-resistant starch contains a processed starch that has been subjected to a hydroxypropylation treatment.

[7] The imitation cheese according to one of [3] to [5], wherein the aging-resistant starch contains a processed starch that has been subjected to a hydroxypropylation treatment.

[8] The imitation cheese according to one of [1] to [7], wherein a proportion of SUS in a triglyceride composition in a fat and oil included in the oil-in-water emulsion composition is 15% by mass or less,
provided that S represents a saturated fatty acid residue of 16 to 18 carbon atoms, U represents an unsaturated fatty acid residue of 16 to 18 carbon atoms, and SUS represents a triglyceride in which one molecule of S is bonded to each of positions 1 and 3 of a glycerin residue in one molecule, and one molecule of U is bonded to position 2.

[9] A method for producing an imitation cheese, the imitation cheese including an oil-in-water emulsion composition containing a nut- and seed-derived material and an aging-resistant starch, the nut- and seed-derived material having a protein content of 15 to 95% by mass, the oil-in-water emulsion composition having a pH of 3.5 to 6.0, the imitation cheese having a protein content of 0.2 to 10.0% by mass, the method for producing an imitation cheese comprising the following (Step 1) to (Step 5):
(Step 1) a step of preparing a preliminary emulsion containing the nut- and seed-derived material, which has a protein content of 15 to 95% by mass, and the aging-resistant starch;
(Step 2) a step of adjusting a pH of the preliminary emulsion to 3.5 to 6.0;
(Step 3) a step of homogenizing the preliminary emulsion to obtain an oil-in-water emulsion composition;
(Step 4) a step of heating the oil-in-water emulsion composition, which is obtained by homogenization, to be at least 80° C. or higher; and
(Step 5) a step of cooling the oil-in-water emulsion composition, which has been heated to be at least 80° C. or higher, to be at least 20° C. or lower.

[10] A food product comprising an imitation cheese including an oil-in-water emulsion composition containing a nut- and seed-derived material and an aging-resistant starch, the nut- and seed-derived material having a protein content of 15 to 95% by mass, the oil-in-water emulsion composition having a pH of 3.5 to 6.0, and the imitation cheese having a protein content of 0.2 to 10.0% by mass.

### Effect of the Invention

According to the present invention, it is possible to obtain an imitation cheese that satisfies all the following items 1) to 4):
1) any odd taste from the imitation cheese is difficult to perceive;
2) the imitation cheese has a favorable texture without a rough texture;
3) the imitation cheese is capable of maintaining smooth physical properties without generation of lumps over the course of multiple days; and
4) the imitation cheese has high emulsion stability and does not undergo oil-water separation.

### EMBODIMENT FOR CARRYING OUT THE INVENTION

Hereinafter, the present invention will be described according to its suitable embodiments. The present invention is not limited by the following description, and each constituent element may be appropriately modified without departing from the scope of the gist of the present invention.

### [Imitation Cheese]

The present invention provides an imitation cheese that includes an oil-in-water emulsion composition containing a nut- and seed-derived material and an aging-resistant starch, the nut- and seed-derived material having a protein content of 15 to 95% by mass. The oil-in-water emulsion composition has a pH of 3.5 to 6.0, and the imitation cheese has a protein content of 0.2 to 10.0% by mass.

### <Oil-In-Water Emulsion Composition>

The imitation cheese of the present invention includes an oil-in-water emulsion composition. The oil-in-water emulsion composition contains a nut- and seed-derived material and an aging-resistant starch, both of which will be described later, and has a pH of 3.5 to 6.0.

Hereinafter, the oil-in-water emulsion composition containing the nut- and seed-derived material and the aging-resistant starch, both of which will be described later, and having a pH of 3.5 to 6.0 may be simply referred to as an “oil-in-water emulsion composition of the present invention”.

In the present invention, the oil-in-water emulsion composition refers to an emulsified composition in which an aqueous phase and an oil phase are emulsified, with the external phase being the aqueous phase. The oil-in-water emulsion composition includes not only an oil-in-water emulsion composition but also a water-in-oil-in-water emulsion composition and the like.

The imitation cheese of the present invention includes the oil-in-water emulsion composition, whereby a favorable texture without a rough texture is obtained, and smooth physical properties can be maintained for an extended period of time.

### <<Fat and Oil>>

The oil-in-water emulsion composition of the present invention contains a fat and oil.

The fat and oil to be included in the oil-in-water emulsion composition of the present invention is not particularly limited as long as it is an edible fat and oil. Examples thereof include vegetable fats and oils such as a palm oil, a palm kernel oil, a coconut oil, a corn oil, a cottonseed oil, a soybean oil, a rapeseed oil, a high erucic acid rapeseed oil, a rice oil, a sesame oil, a safflower oil, a peanut oil, a sunflower oil, a high oleic sunflower oil, a safflower oil, a high oleic safflower oil, a canola oil, a kapok oil, an evening primrose oil, an olive oil, a shea butter, a sal fat, Kokum butter, illipe butter, and cacao butter; animal fats and oils such as milk fat, beef tallow, pork fat, and whale oil; and processed fats and oils obtained by subjecting any of these vegetable fats and oils and animal fats and oils to one type or two or more types of treatments selected from hydrogenation, fractionation, and interesterification. The oil-in-water emulsion composition of the present invention may contain one type or two or more types of fats and oils selected from these fats and oils.

In the present invention, the “processed fats and oils obtained by being subjected to one type or two or more types of treatments selected from hydrogenation, fractionation, and interesterification” may be simply referred to as “processed fats and oils”.

The hydrogenation, fractionation and interesterification for producing the processed fats and oils can be performed by conventionally known methods, and refinement can be performed after these treatments.

The fractionation may be solvent fractionation or dry fractionation.

For interesterification, an enzyme catalyst such as lipase may be used, or a chemical catalyst such as sodium methoxide may be used. In addition, in the present invention, it is preferable to adopt random interesterification from the viewpoint of easily obtaining an imitation cheese that can obtain a texture without a rough texture and maintain smooth physical properties for an extended period of time.

The same applies hereinafter to hydrogenation, fractionation and interesterification for producing processed fats and oils in the present invention.

Examples of the refinement include normal refinement treatments applied to edible fats and oils such as degumming, deacidification, deodorization, and decolorization, and one type or two or more types of these treatments can be performed in accordance with a conventional method.

The amount of fat and oil of the oil-in-water emulsion composition of the present invention can be arbitrarily set depending on the desired texture and physical properties of the imitation cheese to be obtained. From the viewpoint of easily obtaining smooth physical properties and reducing the occurrence of the oil-water separation by enhancing the emulsification stability, the amount of fat and oil of the oil-in-water emulsion composition is preferably 10% by mass or more, more preferably 12% by mass or more, still preferably 14% by mass or more, and the upper limit thereof is preferably 35% by mass or less, more preferably 33% by mass or less, still more preferably 30% by mass or less. Accordingly, in one embodiment, the amount of fat and oil of the oil-in-water emulsion composition is preferably 10 to 35% by mass, more preferably 12 to 33% by mass, still more preferably 14 to 30% by mass.

Note that, in addition to the amount of the fat and oil described above, the amount of fat and oil of the oil-in-water emulsion composition of the present invention is a value that also includes the amounts of fats and oils from nut- and seed-derived materials and aging-resistant starches, which are described later, and from other raw materials of the oil-in-water emulsion composition of the present invention when such fats and oils are contained.

As a method for measuring the amount of fat and oil in the oil-in-water emulsion composition of the present invention, conventionally known methods can be used, and examples thereof include an ether extraction method, a chloroform/methanol mixture extraction method, and an acid decomposition method.

The same applies hereinafter to the method for measuring the amount of fat and oil in the present invention.

From the viewpoint of enabling the suppression of generation of an odd taste in the imitation cheese of the present invention, the content of the animal fat and oil and the processed fat oil in the fat and oil of the oil-in-water emulsion composition of the present invention is preferably 5% by mass or less, more preferably 3% by mass or less, still more preferably 1% by mass or less, and is most preferably 0.1% by mass or less from the viewpoint of making it a plant imitation cheese. The lower limit value of the content of the animal fat and oil and the processed fat and oil is not particularly limited, and is 0% by mass.

The value of the solid fat content at 35° C. of an oil phase (hereinafter, also simply referred to as “SFC at 35° C.”) of the oil-in-water emulsion composition of the present invention is preferably 0.05% or more, 0.08% or more, or 1.0% or more, more preferably 1.5% or more, still more preferably 2.0% or more, and the upper limit thereof is preferably 10.0% or less, more preferably 9.0% or less, still more preferably 8.0% or less. Thus, SFC at 35° C. of the oil phase of the oil-in-water emulsion composition of the present invention is preferably 0.05 to 10.0%, 0.08 to 10.0%, or 1.0 to 10.0%, more preferably 1.5 to 9.0%, still more preferably 2.0 to 8.0%.

When the oil-in-water emulsion composition of the present invention satisfies the above-mentioned preferable numerical value range in SFC at 35° C., which is close to the temperature of the mouth, the texture when eating the imitation cheese of the present invention becomes more favorable.

The SFC at 35° C. of the oil phase of the oil-in-water emulsion composition of the present invention can be determined by measuring SFC at 35° C. using conventionally known methods and converting the obtained measured value into an amount of oil phase. That is, when only the oil phase of the oil-in-water emulsion composition of the present invention is measured, the measured value itself is regarded as the SFC at 35° C., and when the oil phase containing the aqueous phase is measured, the value obtained by converting the measured value to the amount of oil phase is regarded as the SFC at 35° C.

The SFC at 35° C. of the oil phase of the oil-in-water emulsion composition of the present invention can be measured by using “SFC-2000R” manufactured by Astec Co., Ltd. in accordance with the method described in “2. 2. 9-2013 of Standard Methods for the Analysis of Fats, Oils and Related Materials established by Japan Oil Chemists' Society”.

In the fat and oil included in the oil-in-water emulsion composition of the present invention, the proportion of SUS in the triglyceride composition in the fat and oil is preferably 15% by mass or less, more preferably 12% by mass or less, more preferably 9% by mass or less, 8% by mass or less, 6% by mass or less or 5% by mass or less. The lower limit value of the proportion of SUS in the triglyceride composition is not particularly limited, and is 0% by mass.

Here, S represents a saturated fatty acid residue of 16 to 18 carbon atoms, U represents an unsaturated fatty acid residue of 16 to 18 carbon atoms, and SUS represents a triglyceride in which one molecule of S is bonded to each of positions 1 and 3 of a glycerin residue in one molecule, and one molecule of U is bonded to position 2.

In the oil-in-water emulsion composition of the present invention, when the proportion of SUS which tends to become coarse fat-and-oil crystals when crystallized is set to the above-described preferable numerical value range, the imitation cheese of the present invention has a more favorable texture, and furthermore, generation of lumps over the course of multiple days due to the fat-and-oil crystals is suppressed, so that smooth physical properties can be maintained for an extended period of time.

The proportion of SUS in the triglyceride composition of the fat and oil included in the oil-in-water emulsion composition of the present invention can be measured by using conventionally known measuring methods, and for example, by using the method described in “2.4.6.2-2013 of Standard Methods for the Analysis of Fats, Oils and Related Materials established by Japan Oil Chemists' Society” in combination with the silver ion-high performance liquid chromatography method.

From the viewpoint of easily allowing SFC at 35° C. of the oil phase to fall within the above-mentioned preferable numerical value range and favorably obtaining the effects of the present invention, the oil-in-water emulsion composition of the present invention preferably contains at least one of the fat and oil (A) or the fat and oil (B) satisfying the following conditions, and more preferably contains at least the fat and oil (A).
Fat and oil (A): lauric fat and oil
Fat and oil (B): interesterified fat and oil of palm fractionated soft part oil

### <<Fat and Oil (A)>>>

The fat and oil (A) is a lauric fat and oil.

The lauric fat and oil in the present invention refers to a fat and oil having a lauric acid residue content in a constituent fatty acid residue of 20% by mass or more. Specific examples thereof include a palm kernel oil, a coconut oil, processed fats and oils of these fats and oils (e.g., a hydrogenated palm kernel oil, and a fully hydrogenated palm kernel oil), and a processed fat and oil of a fat and oil blend containing one or more types of a palm kernel oil, a coconut oil, and processed fats and oils of these fats and oils.

The oil-in-water emulsion composition of the present invention may contain one type or two or more types of fats and oils (A).

When the oil-in-water emulsion composition of the present invention includes the fat and oil (A), the imitation cheese of the present invention is preferable because a rough texture is suppressed and the texture becomes better, and furthermore, smooth physical properties can be maintained for an extended period of time.

From the viewpoint of obtaining the effects of the present invention more favorably, the oil-in-water emulsion composition of the present invention preferably uses one type or two or more types selected from, among the fats and oils (A), a palm kernel oil, a coconut oil, processed fats and oils of these fats and oils, and interesterified fats and oils of fat and oil blends containing one type or two or more types of a palm kernel oil, a coconut oil, processed fats and oils of these fats and oils. It is more preferable to use one type or two or more types selected from a palm kernel oil, a coconut oil, and interesterified fats and oils of fat and oil blends containing one or more types of a palm kernel oil, a coconut oil, and processed fats and oils of these fats and oils. Since the imitation cheese has a favorable soft texture in addition to the effects of the present invention, it is more preferable to use one type or two or more types selected from among a palm kernel oil and a coconut oil which are non-interesterified fats and oils.

Note that the above-mentioned fat and oil blend containing one or more types of a palm kernel oil, a coconut oil, and processed fats and oils of these fats and oils may contain the palm kernel oil, the coconut oil, and processed fats and oils of these fats and oils in a total amount of 100% by mass in the fat and oil blend, and preferably contains the palm kernel oil, the coconut oil, and processed fats and oils of these fats and oils in a total amount of 40% by mass or more and less than 100% by mass in the fat and oil blend while combining with other fats and oils to make up 100% by mass in total.

The other fats and oils are preferably fats and oils in which the content of saturated fatty acid residues of 16 or more carbon atoms in the constituent fatty acid residue is 70% by mass or more, more preferably 90% by mass or more. As the fats and oils containing 70% by mass or more of saturated fatty acid residues of 16 or more carbon atoms in the constituent fatty acid residue, examples include a fully hydrogenated palm oil, a fully hydrogenated soybean oil, a fully hydrogenated rapeseed oil, a fully hydrogenated pork fat, and a fully hydrogenated beef tallow. One type or two or more types selected from these fats and oils can be used.

From the viewpoint of more favorably obtaining the effects of achieving a more favorable texture without a rough texture, of suppressing generation of lumps over the course of multiple days to obtain smooth physical properties, the water-in-oil emulsion composition of the present invention preferably uses, in combination, one type or two or more types selected from a palm kernel oil and a coconut oil, which are non-interesterified fats and oils, and an interesterified fat and oil of a fat and oil blend containing one or more types of palm kernel oil, coconut oil, and processed fats and oils of these fats and oils described above.

The content of the fat and oil (A) in the oil-in-water emulsion composition of the present invention can be arbitrarily set depending on the texture and physical properties of the desired imitation cheese, but from the viewpoint of favorably obtaining the effects of the present invention, the proportion of the fat and oil (A) relative to the fats and oils in the oil-in-water emulsion composition of the present invention is preferably 70 to 100% by mass, more preferably 80 to 100% by mass, still more preferably 85 to 100% by mass.

### <<Fat and Oil (B)>>>

The fat and oil (B) is an interesterified fat and oil of a palm fractionated soft part oil.

Examples of the palm fractionated soft part oil in the present invention include a palm olein, which is a low melting point fraction obtained by fractionating a palm oil, and a palm superolein, which is a low melting point fraction obtained by further fractionating the palm olein.

The oil-in-water emulsion composition of the present invention may contain one type or two or more types of fats and oils (B).

When the oil-in-water emulsion composition of the present invention includes the fat and oil (B), the hardness of the imitation cheese of the present invention becomes moderate, so that the texture thereof becomes more favorable.

The fat and oil (B) can be produced by interesterification of a fat and oil blend consisting only of one type or two or more types of palm fractionated soft part oils.

From the viewpoint of favorably obtaining the effects of the present invention, the iodine value of the palm fractionated soft part oil used for producing the fat and oil (B) is preferably 52 or more, more preferably 54 or more, 56 or more, or 58 or more, and the upper limit thereof is preferably 70 or less, more preferably 68 or less, still more preferably 66 or less. Thus, in one embodiment, the iodine value of the palm fractionated soft part oil is preferably 52 to 70, more preferably 52 to 68, still more preferably 54 to 66.

In addition, from the viewpoint of more favorably obtaining the effects of the present invention, the iodine value of the fat and oil (B) is preferably 52 or more, more preferably 54 or more, 56 or more, or 58 or more, and the upper limit thereof is preferably 70 or less, more preferably 68 or less, still more preferably 66 or less. Thus, in one embodiment, the iodine value of the fat and oil (B) is preferably 52 to 70, more preferably 52 to 68, still more preferably 54 to 66.

As a method for measuring the iodine value of fats and oils, a conventionally known method can be used, and for example, the iodine value can be measured in accordance with the method described in “2. 3.4.1-2013 of Standard Methods for the Analysis of Fats, Oils and Related Materials established by Japan Oil Chemists' Society”.

The same applies hereinafter to the method for measuring the iodine value of fats and oils in the present invention.

The content of the fat and oil (B) in the oil-in-water emulsion composition of the present invention can be arbitrarily set depending on the texture and physical properties of the desired imitation cheese, but from the viewpoint of favorably obtaining the effects of the present invention, the proportion of the fat and oil (B) relative to the fats and oils in the oil-in-water emulsion composition of the present invention is preferably 70 to 100% by mass, more preferably 80 to 100% by mass, still more preferably 85 to 100% by mass.

In the case where the imitation cheese of the present invention contains both the fat and oil (A) and the fat and oil (B), from the viewpoint of favorably obtaining the effects of the present invention, the proportion of the fat and oil (A) relative to the fats and oils in the oil-in-water emulsion composition is preferably 10% by mass or more, more preferably 20% by mass or more, and the upper limit thereof is preferably 95% by mass or less, more preferably 80% by mass or less. Therefore, in one embodiment in which the oil-in-water emulsion composition contains both the fat and oil (A) and the fat and oil (B), the proportion of the fat and oil (A) relative to the fats and oils in the oil-in-water emulsion composition is preferably 10 to 95% by mass, more preferably 20 to 80% by mass. The proportion of the fat and oil (B) is preferably 5% by mass or more, more preferably 10% by mass or more, and the upper limit thereof is preferably 90% by mass or less, more preferably 60% by mass or less. Therefore, in one embodiment in which the oil-in-water emulsion composition contains both the fat and oil (A) and the fat and oil (B), the proportion of the fat and oil (B) relative to the fats and oils in the oil-in-water emulsion composition is preferably 5 to 90% by mass, more preferably 10 to 60% by mass.

### <<Water Component>>

The oil-in-water emulsion composition of the present invention contains a water component, and may contain water as the water component.

Examples of the water that can be contained in the oil-in-water emulsion composition of the present invention include tap water and mineral water.

The water content of the oil-in-water emulsion composition of the present invention can be arbitrarily set depending on the texture or physical properties of the desired imitation cheese, but from the viewpoint of easily obtaining smooth physical properties without a rough texture and reducing oil-water separation by enhancing the emulsification stability, the water content is preferably 32 to 65% by mass, more preferably 38 to 65% by mass, still more preferably 44 to 65% by mass.

Note that, in addition to the amount of water described above, the water content of the oil-in-water emulsion composition of the present invention is a value that also includes the amounts of water component from nut- and seed-derived materials and aging-resistant starches, which are described later, and other raw materials of the oil-in-water emulsion composition when such a water component is contained.

As a method for measuring the water content of the oil-in-water emulsion composition of the present invention, conventionally known methods can be used, and examples thereof include the Karl Fischer method.

The same applies hereinafter to the method for measuring the water content in the present invention.

### <<Nut- and Seed-Derived Material>>

The oil-in-water emulsion composition of the present invention contains a nut- and seed-derived material having a protein content of 15 to 95% by mass.

The “nuts and seeds” in the present invention refer to edible fruits and seeds enveloped with a hard peel or shell, other than beans and cereal grains. It is noted that although Arachis hypogaea (peanut) belongs to Laguminosae according to plant taxonomy, peanut is often treated as nuts and seeds due to a high oil amount, and thus peanut is also treated as nuts and seeds in the present invention.

Examples of the nuts and seeds used in the present invention include almond, cannabis, flaxseed, apricot kernel, perilla, cashew, ginkgo, chestnut, walnut, poppy seed, coconut, sesame, sweet acorn, chia seed, Japanese horse chestnut seed, pistachio, sunflower seed, brazil nut, hazelnut, pecan, macadamia nut, and peanut. In the present invention, one type or two or more types of nuts and seeds selected from these may be used.

Among these nuts and seeds, from the viewpoint of suppressing the impartment of an odd taste to the imitation cheese of the present invention, from the viewpoint of obtaining a favorable texture without a rough texture and making it possible to maintain smooth physical properties for an extended period of time, and from the viewpoint of enhancing emulsion stability to suppress oil-water separation, one type or two or more types selected from almond, apricot kernel, cashew nut, walnut, coconut, pistachio, sunflower seed, brazil nut, hazelnut, macadamia nut, and peanut are preferably used. Furthermore, one type or two or more types selected from almond, cashew nut, walnut, pistachio, and peanut are more preferably used, and almond is further preferably used.

The nut- and seed-derived material in the present invention refers to unprocessed nuts and seeds or a nut and seed-processed material that has a protein content of 15 to 95% by mass. Hereinafter, the nut- and seed-derived material having a protein content of 15 to 95% by mass is simply referred to as a “nut- and seed-derived material”.

A processing method for obtaining the nut and seed-processed material is not particularly limited, and examples thereof include pulverization, cutting, grinding, extraction of a component, separation of a component, isolation of a component, and concentration of a component, heating, cooling, freezing, and drying. Examples of the nut and seed-processed material include processed materials obtained by extraction or the like of a specific component from nuts and seeds, such as a nut and seed protein material or a nut and seed starch material, and a nut and seed plant milk, such as almond milk. Examples of the nut- and seed-derived material include a nut and seed-containing food material, such as praline paste and gianduja. Among these, a food material containing 25% by mass or more of nut and seed is preferred.

The oil-in-water emulsion composition of the present invention contains one type or two or more types of nut- and seed-derived materials of the present invention.

The form of the nut- and seed-derived material is not particularly limited, and may be, for example, the original form of nut and seed, a powder, a granule, a liquid, or a paste.

In the present invention, the form of the nut- and seed-derived material is preferably a powder, a granule, a liquid, or a paste, more preferably a powder, a liquid, or a paste.

It is noted that in the nut- and seed-derived material, the granule refers to a granule having a particle diameter of more than 0.5 mm and 3 mm or less, and the powder refers to a powder having a particle diameter of 0.5 mm or less, preferably 0.01 to 0.3 mm.

The paste refers to a material in which nuts and seeds are dispersed in a fat and oil or a water component contained in the nuts or seeds, or another food material such as water. In the present invention, as the paste, a material having flowability, a material having viscosity, or the like may be used.

In the present invention, from the viewpoint of improving the texture of the imitation cheese of the present invention, maintaining smooth physical properties for an extended period of time, and suppressing oil-water separation, as the nut- and seed-derived material, one type or two or more types selected from the unprocessed nuts and seeds, the nut and seed powder, granule, and paste, the nut and seed protein material, and the nut and seed plant milk are preferably used, one type or two or more types selected from the nut and seed powder, granule, and paste, the nut and seed protein material, and the nut and seed plant milk are more preferably used, and the nut and seed powder and the nut and seed protein material are still more preferably used.

When the protein content of the nut- and seed-derived material is 15% by mass or more, the oil-water separation during adjustment of the pH of the oil-in-water emulsion composition of the present invention within the numerical value range described below can also be suppressed, and smooth physical properties can be obtained. When the protein content of the nut- and seed-derived material is 95% by mass or less, the generation of an odd taste in the imitation cheese of the present invention can be suppressed.

From the viewpoint of improving the taste of the imitation cheese of the present invention and maintaining smooth physical properties for an extended period of time, the protein content of the nut- and seed-derived material of the present invention is preferably 20% by mass or more, more preferably 30% by mass or more, still more preferably 35% by mass or more, and the upper limit thereof is 95% by mass or less. In one embodiment, the protein content of the nut- and seed-derived material is preferably 20 to 95% by mass, more preferably 30 to 95% by mass, still more preferably 35 to 95% by mass.

As a method for measuring the protein content of the nut- and seed-derived material, a conventionally known method may be used, and examples thereof include a Kjeldahl method and a combustion method.

The same applies hereinafter to a method for measuring a protein content in the present invention.

The imitation cheese of the present invention solves the problems in the conventional imitation cheese by using the nut- and seed-derived material having a protein content within a specific range together with an aging-resistant starch, which will be described below.

That is, according to the present invention, it is possible to obtain an imitation cheese that not only can solve the occurrence of odd taste, roughness, and oil-water separation during adjustment of pH to an acidic level, but also can maintain smooth physical properties for an extended period of time while a change in physical properties due to protein denaturation of the plant-derived raw material, or due to other causes is reduced.

In the present invention, the amount of fat and oil of the nut- and seed-derived material is preferably 60% by mass or less, 58% by mass or less, 56% by mass or less or 55% by mass or less, more preferably 50% by mass or less or 45% by mass or less, more preferably 40% by mass or less, further more preferably 35% by mass or less, particularly preferably 30% by mass or less, 25% by mass or less or 20% by mass or less. The lower limit of the amount of fat and oil is not particularly limited, and may be 0% by mass, or may be 0.05% by mass or more, 0.1% by mass or more, or the like. Thus, in one embodiment, the amount of fat and oil of the nut- and seed-derived material is 0 to 60% by mass (e.g., 0 to 55% by mass, 0 to 50% by mass, 0 to 45% by mass), more preferably 0.1 to 35% by mass, further preferably 0.1 to 30% by mass, still more preferably 0.1 to 25% by mass.

When the nut- and seed-derived material satisfies the preferable amount of fats and oils, an imitation cheese having a favorable taste can be obtained because any odd taste caused by the fat and oil derived from the nut- and seed-derived material from the imitation cheese is difficult to perceive. In addition, a more favorable texture can be obtained and smooth physical properties can be maintained for an extended period of time.

The amount of fat and oil of the nut- and seed-derived material relative to 1 part by mass of a protein, while the above-described protein content and the above-described preferable amount of fats and oils are satisfied, is preferably 4.0 parts by mass or less, 3.5 parts by mass or less, 3.0 parts by mass or less or 2.5 parts by mass or less, more preferably 2.0 parts by mass or less or 1.5 parts by mass or less, more preferably 1 part by mass or less, 0.8 part by mass or less, 0.6 part by mass or less, or 0.5 part by mass or less, and the lower limit is preferably 0 parts by mass or more, more preferably 0.005 part by mass or more, more preferably 0.01 part by mass or more. Therefore, in one embodiment, the amount of fat and oil relative to 1 part by mass of the protein content is preferably 2.0 parts by mass or less, more preferably 0.005 to 1.5 parts by mass, still more preferably 0.01 to 1.0 part by mass.

When the ratio between the protein content of the nut- and seed-derived material and the amount of fat and oil of the nut- and seed-derived material satisfies the above-described preferable numerical range, the imitation cheese of the present invention from which any odd taste is difficult to perceive, which has a favorable texture without a rough texture, and can maintain smooth physical properties for an extended period of time can be obtained, and thus it is preferable.

From the viewpoint of suppressing a change in physical properties of starch, dietary fibers, and the like, which may cause the generation of lumps over the course of multiple days, to improve the texture of the imitation cheese of the present invention, and making it possible to maintain smooth physical properties for an extended period of time, the carbohydrate content of the nut- and seed-derived material is preferably 50% by mass or less, more preferably 45% by mass or less, still more preferably 40% by mass or less. The lower limit value of the carbohydrate content is 0% by mass.

As a method for measuring the carbohydrate content of the nut- and seed-derived material, a conventionally known method may be used. Examples thereof include a method in which the total amount of protein, fat and oil, ash, and the water component separately measured is subtracted from the weight of the nut- and seed-derived material to obtain the carbohydrate amount of the nut- and seed-derived material, and the obtained carbohydrate amount of the nut- and seed-derived material is divided by the weight of the nut- and seed-derived material.

The same applies hereinafter to a method for measuring a carbohydrate content in the present invention.

As a method for measuring the ash content of the nut- and seed-derived material, a conventionally known method may be used. Examples thereof include a magnesium acetate addition ashing method and a direct ashing method.

Further, from the viewpoint of favorably obtaining the effects of the present invention, the water content of the nut- and seed-derived material is preferably 60% by mass or less, more preferably 40% by mass or less, still more preferably 20% by mass or less. The lower limit value of water content is 0% by mass.

The content of the nut- and seed-derived material in the oil-in-water emulsion composition of the present invention is preferably 0.1% by mass or more, more preferably 0.5% by mass or more, still more preferably 0.8% by mass or more, 1% by mass or more, 1.2% by mass or more, 1.4% by mass or more or 1.5% by mass or more, and the upper limit thereof is preferably 10% by mass or less, more preferably 8% by mass or less, still more preferably 7.5% by mass or less, 6% by mass or less, 5% by mass or less, 4% by mass or less, or less than 4% by mass, from the viewpoint of favorably obtaining the effects of the present invention. Thus, in one embodiment, the imitation cheese of the present invention preferably contains 0.1 to 10% by mass of the nut- and seed-derived material, more preferably 0.5 to 8% by mass, still more preferably 0.8 to 6% by mass, even more preferably 1% to less than 4% by mass, in the oil-in-water emulsion composition.

From the viewpoint of easily obtaining the imitation cheese of the present invention from which any odd taste is difficult to perceive, that has a favorable texture without a rough texture, that maintains smooth physical properties for an extended period of time, and that suppresses the oil-water separation, the content of the nut- and seed-derived material in the oil-in-water emulsion composition of the present invention as a solid content is preferably 0.5% by mass or more, more preferably 0.7% by mass or more, still more preferably 1.0% by mass or more, and the upper limit thereof is preferably 6.0% by mass or less, more preferably 5.0% by mass or less, still more preferably 4.5% by mass or less, 4.0% by mass or less, or 3.5% by mass or less. Therefore, in one embodiment, the content of the nut- and seed-derived material in the oil-in-water emulsion composition as a solid content is preferably 0.5 to 6.0% by mass, more preferably 0.7 to 4.5% by mass, further preferably 1.0 to 4.5% by mass, still more preferably 1.0 to 3.5% by mass.

The solid content in the present invention refers to a component other than the water component.

### <<Aging-Resistant Starch>>

The oil-in-water emulsion composition of the present invention contains an aging-resistant starch in addition to the nut- and seed-derived material.

The aging-resistant starch in the present invention refers to a processed starch in which, for example, a raw material starch to be described later is subjected to an aging-resistance treatment such as an acetylation treatment or a hydroxypropylation treatment to reduce, as compared with the raw material starch, the occurrence of a phenomenon (aging phenomenon) in which a gelatinized starch is hardened by the passage of time or cooling.

The raw material starch in the present invention refers to an unprocessed starch such as a starch derived from corn (e.g., waxy corn and non-waxy corn), a wheat-derived starch, and a potato-derived starch.

Examples of the aging-resistant starch used in the present invention include processed starches obtained by subjecting a raw material starch to one type or two or more types of aging-resistance treatments selected from the group consisting of an acetylation treatment with acetic anhydride or the like, a hydroxypropylation treatment with propylene oxide or the like, a phosphorylation treatment with sodium trimetaphosphate or the like, and an oxidation treatment with sodium hypochlorite or the like.

When the oil-in-water emulsion composition of the present invention includes the aging-resistant starch in combination with the nut- and seed-derived material, it is possible to obtain the imitation cheese of the present invention that has a favorable texture without a rough texture, that does not generate lumps over the course of multiple days, and that can maintain smooth physical properties for an extended period of time. In addition, the present invention provides an imitation cheese that has high emulsification stability and that does not undergo oil-water separation.

From the viewpoint of favorably obtaining the effects of maintaining a favorable texture and smooth physical properties for an extended period of time and the effect of preventing oil-water separation from occurring, the aging-resistant starch used in the present invention preferably contains a processed starch that has been subjected to a hydroxypropylation treatment.

In addition, when the processed starch that has been subjected to a hydroxypropylation treatment is contained, the content thereof is preferably 50 to 100% by mass, more preferably 70 to 100% by mass, in the aging-resistant starch used in the oil-in-water emulsion of the present invention, from the viewpoint of more favorably obtaining the effects of the present invention.

The aging-resistant starch used in the present invention may be obtained by subjecting a raw material starch to one type or two or more types of treatments, other than an aging-resistance treatment, selected from physical treatments such as a bleaching treatment and a moist heat treatment, chemical treatments such as an esterification treatment, an etherification treatment, a crosslinking treatment and an emulsifier treatment, and an enzymatic treatment, in addition to the aging-resistance treatment.

When the aging-resistant starch used in the present invention is obtained by subjecting the raw material starch to an aging-resistance treatment and a treatment other than the aging-resistance treatment, the order of the treatments is not particularly limited and the treatments may be performed in any order or simultaneously if possible.

In the present invention, from the viewpoint of more favorably obtaining the effects of maintaining a favorable texture and smooth physical properties for an extended period of time, the aging-resistant starch used in the present invention is preferably subjected to a crosslinking treatment as a treatment other than the aging-resistance treatment, and more preferably subjected to a phosphoric acid crosslinking treatment among crosslinking treatments.

A preferred aspect of the aging-resistant starch used in the present invention includes a phosphoric acid-crosslinked aging-resistant starch, and a more preferred aspect includes a hydroxypropylated phosphoric acid-crosslinked aging-resistant starch.

The oil-in-water emulsion composition of the present invention may use, as the aging-resistant starch, one type or a combination of two or more types of processed starches selected from aging-resistant starches obtained through different treatments and aging-resistant starches obtained through the same treatment but to varying degrees.

In the present invention, there is no particular limitation on the type of raw material starch used for producing the aging-resistant starch, and examples thereof include a waxy corn-derived raw material starch, a non-waxy corn-derived raw material starch (hereinafter, simply referred to as corn), a tapioca-derived raw material starch, a wheat-derived raw material starch, a sweet potato-derived raw material starch, a potato-derived raw material starch, a sago-derived raw material starch, a rice-derived raw material starch, and a glutinous rice-derived raw material starch.

The aging-resistant starch used in the present invention can be produced by combining one type or two or more types of raw material starches.

From the viewpoint of more favorably obtaining the effects of improving the texture of the imitation cheese of the present invention, maintaining smooth physical properties for an extended period of time, and being less likely to occur oil-water separation, the oil-in-water emulsion composition of the present invention preferably contains, as an aging-resistant starch, an aging-resistant starch (α) that satisfies the following conditions.

In addition, from the viewpoint of obtaining a more favorable texture and easily obtaining the effect of maintaining smooth physical properties for an extended period of time, it is more preferable to contain both the aging-resistant starch (α) and the aging-resistant starch (β) that satisfy the following conditions.

Aging-resistant starch (α): Aging-resistant starch obtained from a raw material starch having an amylose content of 10 to 40% by mass in the raw material starch

Aging-resistant starch (β): Aging-resistant starch obtained from a raw material starch having an amylose content of less than 10% by mass in the raw material starch

Examples of the raw material starch used for obtaining the aging-resistant starch (α) having an amylose content of 10 to 40% by mass in the raw material starch include a corn-derived raw material starch, a tapioca-derived raw material starch, a wheat-derived raw material starch, a sweet potato-derived raw material starch, a potato-derived raw material starch, a sago-derived raw material starch, and a rice-derived raw material starch. Examples of the aging-resistant starch (α) include aging-resistant starches obtained by subjecting a raw material starch such as a corn-derived raw material starch, a tapioca-derived raw material starch, a wheat-derived raw material starch, a sweet potato-derived raw material starch, a potato-derived raw material starch, a sago-derived raw material starch, or a rice-derived raw material starch to a certain treatment.

From the viewpoint of favorably obtaining the effects of the present invention, the amylose content in the raw material starch used for obtaining the aging-resistant starch (α) is preferably 10 to 35% by mass, more preferably 10 to 30% by mass.

As a method for measuring the amylose content in the raw material starch, a conventionally known method can be used, and examples thereof include an iodine affinity measuring method and an iodine colorimetric method.

The same applies hereinafter to the method for measuring the amylose content of the raw material starch in the present invention.

When the oil-in-water emulsion composition of the present invention includes the aging-resistant starch (α), from the viewpoint of more favorably obtaining the effects of the present invention, the content of the aging-resistant starch (α) in the oil-in-water emulsion composition is preferably 0.7% by mass or more, more preferably 1.0% by mass or more, still more preferably 1.5% by mass or more, and the upper limit thereof is preferably 10.0% by mass or less, more preferably 8.0% by mass or less, still more preferably 6.0% by mass or less. Accordingly, in one embodiment, the content of the aging-resistant starch (α) in the oil-in-water emulsion composition is preferably 0.7 to 10.0% by mass, more preferably 1.0 to 8.0% by mass, still more preferably 1.5 to 6.0% by mass.

Examples of the raw material starch that is used for obtaining the aging-resistant starch (β) and that has an amylose content of less than 10% by mass in the raw material starch include a waxy corn-derived raw material starch and a glutinous rice-derived raw material starch. Examples of the aging-resistant starch (β) include an aging-resistant starch obtained by subjecting a raw material starch such as a waxy corn-derived raw material starch or a glutinous rice-derived raw material starch to a certain treatment.

From the viewpoint of more favorably obtaining the effects of the present invention, the amylose content in the raw material starch used for obtaining the aging-resistant starch (β) is preferably 7% by mass or less, more preferably 5% by mass or less. The lower limit value of the amylose content is 0% by mass.

When the oil-in-water emulsion composition of the present invention includes the aging-resistant starch (β), from the viewpoint of more favorably obtaining the effects of the present invention, the content of the aging-resistant starch (β) in the oil-in-water emulsion composition as the solid content is preferably 0.1% by mass or more, more preferably 0.3% by mass or more, still more preferably 0.5% by mass or more, and the upper limit thereof is preferably 8.0% by mass or less, more preferably 6.5% by mass or less, still more preferably 5.0% by mass or less. Accordingly, in one embodiment, the content of the aging-resistant starch (β) in the oil-in-water emulsion composition is preferably 0.1 to 8.0% by mass, more preferably 0.3 to 6.5% by mass, even more preferably 0.5 to 5.0% by mass.

In addition, from the viewpoint of more favorably obtaining the effects of the present invention, the total content of the aging-resistant starch (α) and the aging-resistant starch (β) in the aging-resistant starch included in the oil-in-water emulsion composition is preferably 70 to 100% by mass, and more preferably 85 to 100% by mass.

Examples of the aging-resistant starch other than the aging-resistant starch (α) and the aging-resistant starch (β) include raw material starches having an amylose content of more than 40% by mass in the raw material starch, for example, aging-resistant starches obtained from raw material starches such as a high amylose corn-derived raw material starch and a high amylose wheat-derived raw material starch.

When the oil-in-water emulsion composition of the present invention includes the aging-resistant starch (α) and the aging-resistant starch (β), the blending ratio of the aging-resistant starch (α) and the aging-resistant starch (β) can be arbitrarily set depending on the texture and physical properties of the desired imitation cheese of the present invention.

In this case, from the viewpoint of more favorably obtaining the effects of obtaining a favorable texture, preventing generation of lumps over the course of multiple days, and maintaining smooth physical properties for an extended period of time, the content of the aging-resistant starch (β) in the imitation cheese of the present invention as a solid content relative to 1 part by mass of the solid content of the aging resistant starch (α) in the imitation cheese of the present invention is preferably 0.05 part by mass or more, more preferably 0.1 part by mass or more, still more preferably 0.2 part by mass or more, and the upper limit thereof is preferably 8.0 parts by mass or less, more preferably 6.5 parts by mass or less, still more preferably 5.0 parts by mass or less. Thus, in one embodiment, the content of the aging-resistant starch (β) relative to 1 part by mass of the aging-resistant starch (a) is preferably 0.05 to 8.0 parts by mass, more preferably 0.1 to 6.5 parts by mass, still more preferably 0.2 to 5.0 parts by mass.

The content of the aging-resistant starch in the oil-in-water emulsion composition of the present invention can be arbitrarily set depending on the texture and physical properties of the desired imitation cheese of the present invention. From the viewpoint of more favorably obtaining the effects of maintaining a favorable texture without a rough texture, and smooth physical properties for an extended period of time, while preventing generation of lumps over the course of multiple days, the content of the aging resistant starch as a solid content is preferably 1.0% by mass or more, more preferably 2.0% by mass or more, still more preferably 3.0% by mass or more, and the upper limit thereof is preferably 12.0% by mass or less, more preferably 10.0% by mass or less, still more preferably 8.0% by mass or less. Thus, in one embodiment, the content of the aging-resistant starch in the oil-in-water emulsion composition is preferably 1.0 to 12.0% by mass, more preferably 2.0 to 10.0% by mass, even more preferably 3.0 to 8.0% by mass.

In addition, in the imitation cheese of the present invention, from the viewpoint of more favorably obtaining the effects of maintaining a favorable texture without a rough texture, and smooth physical properties for an extended period of time, the content of the aging-resistant starch relative to 1 part by mass of the solid content of the nut- and seed-derived material in the oil-in-water emulsion composition of the present invention is preferably 1.0 part by mass or more, more preferably 1.5 parts by mass or more, still more preferably 2.0 parts by mass or more while the preferable numerical ranges of the contents of the nut- and seed-derived material and the aging-resistant starch of the present invention are satisfied. The upper limit thereof is preferably 10.0 parts by mass or less, more preferably 8.0 parts by mass or less, still more preferably 6.0 parts by mass or less. Thus, in one embodiment, the content of the aging-resistant starch in the oil-in-water emulsion composition relative to 1 part by mass of the solid content of the nut- and seed-derived material of the present invention is preferably 1.0 to 10.0 parts by mass, more preferably 1.5 to 8.0 parts by mass, still more preferably 2.0 to 6.0 parts by mass.

### <<Other Raw Materials>>

The oil-in-water emulsion composition of the present invention may contain other raw materials than the above-mentioned materials as long as the effects of the present invention are not impaired.

Examples of other raw materials include food raw materials and food additives, such as raw material starches, processed starches other than the aging-resistant starches, sugars, a sugar alcohol, a high-intensity sweetener, a salting agent such as common salt and potassium chloride, a seasoning, a spice, an acidulant, a pH adjuster, a thickening stabilizer, an emulsifier, enzymes, a coloring agent such as β-carotene and caramel, a flavoring agent, an antioxidant such as tocopherol, a food preservative, a shelf life enhancer, fruits, vegetables, fruit pulps and fruit juices, a fruit, beans and grains and food materials derived from these, milk products such as milk and cheese, plant milk other than plant milk corresponding to the nut- and seed-derived material such as soy milk, oat milk, rice milk and the like, coffee, cacao mass, cocoa powder, and alcoholic beverages such as wine. One type or two or more types of these other raw materials may be contained.

The content of the other raw materials used in the oil-in-water emulsion composition of the present invention as a solid content is preferably 30% by mass or less, more preferably 25% by mass or less, in the oil-in-water emulsion composition of the present invention. The lower limit value of the content of the other raw materials is 0% by mass.

In the imitation cheese of the present invention, from the viewpoint of preventing generation of lumps over the course of multiple days, and maintaining smooth physical properties for an extended period of time, the content of the raw material starch in the oil-in-water emulsion composition of the present invention as a solid content is preferably 5% by mass or less, more preferably 3% by mass or less, still more preferably 1% by mass or less, and most preferably 0.5% by mass or less.

In addition, from the viewpoint of improving the texture of the imitation cheese of the present invention and being likely to maintain smooth physical properties for an extended period of time, the oil-in-water emulsion composition of the present invention preferably contains 3 to 15% by mass, more preferably 5 to 12% by mass, of sugars and a sugar alcohol as a total solid content in the oil-in-water emulsion composition of the present invention.

Examples of the sugars include monosaccharides, disaccharides, oligosaccharides, and polysaccharides such as super fine sugar, brown sugar, sucrose, glucose, fructose, lactose, granulated sugar, molasses sugar, black sugar, maltose, beet sugar, cane sugar, powdered sugar, liquid sugar, isomerized sugar, invert sugar, enzyme-saccharified starch syrup, isomerized starch syrup, sucrose-bound starch syrup, fructooligosaccharide, soybean oligosaccharide, galactooligosaccharide, lactofructonse oligosaccharide, xylose, trehalose, raffinose, lactulose, and palatinose oligosaccharide.

Examples of the sugar alcohol include sorbitol, xylitol, maltitol, erythritol, mannitol, lactitol, reduced maltose syrup, reduced lactose, and reduced starch syrup.

The present invention preferably contains, among these sugars and sugar alcohols, sugars, more preferably sugars selected from disaccharides, oligosaccharides, and polysaccharides, still more preferably sugars selected from disaccharides, and most preferably trehalose.

In the present invention, the term “oligosaccharide” refers to a sugar in which 3 to 10 monosaccharides are bonded, and the term “polysaccharide” refers to a sugar in which 11 or more monosaccharides are bonded.

In addition, from the viewpoint of being capable of obtaining a favorable texture of the imitation cheese of the present invention and maintaining a smooth physical property for an extended period of time, the content of the enzymes of the oil-in-water emulsion composition of the present invention is preferably 0.01% by mass or less, more preferably 0.005% by mass or less, in the oil-in-water emulsion composition of the present invention, and still more preferably no enzymes are contained.

Examples of the enzymes include enzymes commonly used in food products such as proteolytic enzymes such as chymosin, pepsin, trypsin, and protease, and carbohydrate degrading enzymes such as transglutaminase, lactase, α-amylase, β-amylase, and glucoamylase.

In addition, from the viewpoint of imparting a rich taste to the imitation cheese of the present invention to improve a favorable taste, the oil-in-water emulsion composition of the present invention may contain plant milk other than the plant milk corresponding to the nut- and seed-derived material of the present invention.

Such plant milk is a food or food raw material in a paste or liquid form and is produced by adding water to a plant raw material and grinding it, and such plant milk often has a milky white cloudy appearance.

Examples of such plant milk other than plant milks corresponding to the nut- and seed-derived material include plant milk produced from beans and cereals such as soymilk, oat milk, and rice milk, and plant milk produced from the seeds as a raw material, the plant milks having a protein content of less than 15% by mass.

Note that such plant milk other than the plant milk corresponding to the nut- and seed-derived material may contain a solid content generated by grinding, or may be obtained by reducing the solid content by filtration or the like. Also examples of such plant milk include those obtained by simple squeezing, and commercially available products.

When such plant milk other than the plant milk corresponding to the nut- and seed-derived material is contained, the content thereof as a solid content is preferably 0.1 to 1.5% by mass, more preferably 0.1 to 1.2% by mass, in the oil-in-water emulsion composition of the present invention. When such plant milk other than the plant milk corresponding to the nut- and seed-derived material satisfies the above-described preferable numerical range, it is possible to obtain the effects of the present invention of imparting a rich taste to the imitation cheese while any odd taste from the imitation cheese is difficult to perceive.

<<pH>>

The pH of the oil-in-water emulsion composition of the present invention is 3.5 to 6.0.

When the pH of the oil-in-water emulsion composition of the present invention falls within the above-described range, it is possible to obtain an imitation cheese having a favorable taste to which a cheese-like sourness is imparted while improving the emulsification stability and suppressing the occurrence of oil-water separation.

From the viewpoint of obtaining a favorable taste while improving the emulsion stability, the pH of the oil-in-water emulsion composition (and thus the imitation cheese) of the present invention is 3.5 or more, preferably 3.6 or more, more preferably 3.7 or more, and the upper limit thereof is preferably 5.8 or less, more preferably 5.5 or less, still more preferably 5.0 or less. Thus, in one embodiment, the pH of the oil-in-water emulsion composition is preferably 3.5 to 5.8, more preferably 3.5 to 5.5, even more preferably 3.5 to 5.0.

Note that, in the present invention, the pH of the preliminary emulsion (after pH adjustment; after (Step 2) described later) in the production process of the imitation cheese of the present invention, or the pH of the oil-in-water emulsion composition prior to the heating step obtained by homogenizing the preliminary emulsion (after pH adjustment; after (Step 2) and (Step 3) described later) is defined as the pH of the oil-in-water emulsion composition of the present invention.

As a method for measuring the pH of the oil-in-water emulsion composition of the present invention, a conventionally known method can be used, and for example, a preliminary emulsion in a process for producing an imitation cheese of the present invention described later or an oil-in-water emulsion composition obtained by homogenizing the preliminary emulsion before the heating process can be adjusted to a temperature of 50 to 65° C. and measured using a pH measuring instrument.

As the method for adjusting the pH of the oil-in-water emulsion composition of the present invention to the above-described numerical range, from the viewpoint of improving the taste of the imitation cheese of the present invention, it is preferable to adjust the pH of the oil-in-water emulsion composition by using an organic acid or a food material that contains an organic acid or by performing organic acid fermentation. From the viewpoint of facilitating pH adjustment, it is more preferable to use an organic acid or a food material that contains an organic acid.

Examples of the organic acid to be contained include adipic acid, citric acid, gluconic acid, succinic acid, acetic acid, tartaric acid, lactic acid (including fermented lactic acid), fumaric acid, malic acid, phosphoric acid, and phytic acid.

The food material that contains an organic acid that can be contained is not particularly limited, and examples of the food material that can be preferably used in the present invention include fruits and juices such as orange, strawberry, grape, lemon, pine apple, and apple, fermented foods such as cheese, fermented milk, and vinegar, and coffee. In addition, a processed product such as a paste, puree, or jam of a food material that contains an organic acid can also be used.

One type or two or more types of organic acid or food material containing the organic acid can be used, and the blending amount thereof can be appropriately adjusted so as to fall within the above-mentioned pH range.

### <Components and Features of Imitation Cheese of the Present Invention>

The imitation cheese of the present invention includes the oil-in-water emulsion composition of the present invention, and the protein content in the imitation cheese needs to be 0.2 to 10.0% by mass.

When the protein content of the imitation cheese of the present invention satisfies the above-mentioned numerical range, the imitation cheese from which an odd taste is difficult to perceive, has a favorable texture without a rough texture, that can maintain smooth physical properties for an extended period of time, and that does not undergo oil-water separation can be obtained.

From the viewpoint of more favorably obtaining the effects of the present invention, the protein content in the imitation cheese of the present invention is preferably 0.2% by mass or more, more preferably 0.3% by mass or more, still more preferably 0.35% by mass or more, 0.4% by mass or more, 0.45% by mass or more, or 0.5% by mass or more, and the upper limit thereof is preferably 6.0% by mass or less, more preferably 4.5% by mass or less, still more preferably 2.5% by mass or less. Therefore, in one embodiment, the protein content in the imitation cheese of the present invention is preferably 0.2 to 6.0% by mass, more preferably 0.3 to 4.5% by mass, still more preferably 0.35 to 2.5% by mass or 0.5 to 2.5% by mass.

From the viewpoint of making it possible to maintain smooth physical properties for an extended period of time, the carbohydrate content of the imitation cheese of the present invention is preferably 30% by mass or less, more preferably 25% by mass or less, still more preferably 20% by mass or less, in the imitation cheese. The lower limit value of the carbohydrate content of the imitation cheese of the present invention is 0% by mass.

The properties of the imitation cheese of the present invention is preferably semi-solid or solid at normal temperature (20 to 25° C.).

### <Method for Producing Imitation Cheese of the Present Invention>

A method for producing the imitation cheese of the present invention will be described. Hereinafter, the method for producing the imitation cheese of the present invention is simply referred to as the “production method of the present invention”.

The production method of the present invention includes the following (Step 1) to (Step 5). It is preferable that in the production method of the present invention, the following (Step 1) to (Step 5) be performed in this order:
(Step 1) a step of preparing a preliminary emulsion containing the nut- and seed-derived material and the aging-resistant starch, the nut- and seed-derived material having a protein content of 15 to 95% by mass;
(Step 2) a step of adjusting a pH of the preliminary emulsion to 3.5 to 6.0;
(Step 3) a step of homogenizing the preliminary emulsion to obtain an oil-in-water emulsion composition;
(Step 4) a step of heating the oil-in-water emulsion composition, which is obtained by homogenization, to be at least 80° C. or higher; and
(Step 5) a step of cooling the oil-in-water emulsion composition, which has been heated to be at least 80° C. or higher, to be at least 20° C. or lower.

The details of the imitation cheese of the present invention are as described above.

Hereinafter, a suitable production method of the present invention will be described.

### <<Regarding (Step 1)>>

(Step 1) is a step of preparing a preliminary emulsion containing the nut- and seed-derived material and the aging-resistant starch, the nut- and seed-derived material having a protein content of 15 to 95% by mass.

Hereinafter, the preliminary emulsion containing the nut- and seed-derived material, having a protein content of 15 to 95% by mass, and the aging-resistant starch is simply referred to as “preliminary emulsion”.

Specifically, a fat and oil is heated and melted followed by mixing. Then, the nut- and seed-derived material having a protein content of 15 to 95% by mass and, as necessary, other oil-soluble raw materials are added, stirred, and mixed to obtain an oil phase.

Next, the aging-resistant starch is added to water, and as necessary, other water-soluble raw materials are further added, stirred, and mixed to obtain an aqueous phase.

The oil phase is added to the resulting aqueous phase, and mixed to obtain an oil-in-water preliminary emulsion.

From the viewpoint of more favorably obtaining the effects of the present invention, the amount of added oil phase is preferably 0.1 to 0.6 times, more preferably 0.2 to 0.5 times, the amount of the aqueous phase.

From the viewpoint of avoiding an increase in viscosity of the preliminary emulsion and achieving efficient production, the temperature of the preliminary emulsion in (Step 1) in the production method of the present invention varies depending on the melting point of the contained fat and oil, or the like, and is preferably 45 to 75° C.

### <<Regarding (Step 2)>>

(Step 2) is a step of adjusting a pH of the preliminary emulsion to 3.5 to 6.0.

From the viewpoint of making it possible to impart a favorable taste that is a sour taste to the imitation cheese obtained by the production method of the present invention while favorable emulsion stability is achieved, in the production method of the present invention, the pH of the preliminary emulsion is adjusted to be preferably 3.5 to 5.8, more preferably 3.5 to 5.5, still more preferably 3.5 to 5.2.

From the viewpoint of improving the taste of the imitation cheese of the present invention, the method for adjusting the pH of the preliminary emulsion to be within the above-mentioned numerical range preferably involves using an organic acid or a food material that contains an organic acid or performing organic acid fermentation. From the viewpoint of facilitating the pH adjustment, it is preferable to add an organic acid or a food material that contains an organic acid to the preliminary emulsion.

The organic acid or the food material that contains an organic acid that can be used is as described above.

(Step 2) in the production method of the present invention may be performed after (Step 3) described below.

In this case, (Step 2) may be a step of adjusting the pH of the oil-in-water emulsion composition, which has been obtained by homogenization of the preliminary emulsion, to 3.5 to 6.0.

### <<Regarding (Step 3)>>

(Step 3) is a step of homogenizing the preliminary emulsion to obtain an oil-in-water emulsion composition.

The step of homogenization in the method for producing the imitation cheese of the present invention is a step of homogenizing the preliminary emulsion, preferably the preliminary emulsion having a pH of 3.5 to 6.0 obtained in (Step 2), with a homogenizer such as a valve homogenizer, a homomixer, or a colloidal mill to obtain an oil-in-water emulsion composition.

The homogenization pressure is not particularly limited, and is preferably 0 to 200 MPa. When homogenization is performed using a two-stage homogenizer, for example, the first stage is preferably performed at 1 to 150 MPa and the second stage is preferably performed at 3 to 200 MPa.

### <<Regarding (Step 4)>>

(Step 4) is a step of heating the oil-in-water emulsion composition, which has been obtained by homogenization of the preliminary emulsion, to be at least 80° C. or higher.

In the method for producing the imitation cheese of the present invention, when the oil-in-water emulsion composition obtained by homogenization of the preliminary emulsion is heated to be at least 80° C. or higher, the imitation cheese having a favorable texture without a rough texture can be obtained.

The heating can be performed, for example, by heating treatment by UHT and HTST using direct heating methods such as injection type and infusion type or using indirect heating methods such as plate type, tubular type, and scraping type, and by heating treatment by batch-type, retort, microwave heating, or by heat cooking using direct fire or the like.

The heating is not particularly limited as long as the heating temperature is at least 80° C. or higher, but the heating is preferably performed at 85° C. or higher, more preferably at 90° C. or higher.

The upper limit of the heating temperature can be optionally set within the range where the oil-in-water emulsion composition is not burnt, and is preferably 150° C. or lower, more preferably 140° C. or lower, still more preferably 130° C. or lower. The heating time is preferably 1 second to 15 minutes.

### <<Regarding (Step 5)>>

(Step 5) is a step of cooling the oil-in-water emulsion composition, which has been heated to be at least 80° C. or higher, to be at least 20° C. or lower.

When the oil-in-water emulsion composition heated to be at least 80° C. or higher is cooled to be at least 20° C. or lower, an imitation cheese having a favorable texture without a rough texture and smooth physical properties can be obtained.

In the method for producing the imitation cheese of the present invention, the oil-in-water emulsion composition heated to be at least 80° C. or higher is cooled to be preferably 15° C. or lower, more preferably 10° C. or lower. The lower limit value of the cooling temperature can be optionally set within the range where the oil-in-water emulsion composition is not frozen, and is preferably 3° C. or higher.

In the method for producing the imitation cheese of the present invention, the cooling may be rapid cooling or slow cooling, but from the viewpoint of more favorably obtaining a favorable texture and smooth physical properties, slow cooling is preferred.

In the present invention, rapid cooling refers to cooling at a cooling rate of 1.0° C./min or more, and slow cooling refers to cooling at a cooling rate of less than 1.0° C./min.

The imitation cheese of the present invention obtained through (Step 1) to (Step 5) can be optionally shaped into a block, bar, cylindrical, dice, shred, sheet, or spherical shape.

Preferred sizes for each shape are: block shape with longitudinal dimension of 50 to 1000 mm, lateral dimension of 50 to 1000 mm, and thickness of 50 to 500 mm; bar shape with longitudinal dimension of 1 to 25 mm, lateral dimension of 1 to 25 mm, and length of 5 to 100 mm; cylindrical shape with diameter of 1 to 25 mm and length of 5 to 100 mm; dice shape with longitudinal dimension of 5 to 50 mm, lateral dimension of 5 to 50 mm, and thickness of 5 to 50 mm; shred shape with diameter of 1 to 25 mm and length of 5 to 100 mm; sheet shape with longitudinal dimension of 50 to 1000 mm, lateral dimension of 50 to 1000 mm, and thickness of 1 to 50 mm; and spherical shape with diameter of 10 to 500 mm.

In addition, the imitation cheese of the present invention may be packed or packaged in a container, a bag, or the like with an optional shape.

### <Application of Imitation Cheese of the Present Invention>

The imitation cheese of the present invention, from which any odd taste is difficult to perceive, has a favorable taste that is a cheese-like sour taste, and does not undergo oil-water separation. Accordingly, the imitation cheese of the present invention can be used preferably as a substitute of cheese including: soft cheese such as mozzarella cheese, cream cheese, cottage cheese, mascarpone cheese, ricotta cheese, or Camembert cheese; semi-hard cheese such as Gorgonzola cheese, Gouda cheese, or Roquefort cheese; hard cheese such as Raclette cheese, Emmental cheese, or Cheddar cheese; or ultra-hard cheese such as Parmigiano Reggiano cheese or Romano cheese.

Among these cheeses, the imitation cheese of the present invention is preferably used as a substitute of soft cheese. In particular, the imitation cheese of the present invention has no degree of stringiness, a favorable soft texture, a favorable texture without a rough texture, and smooth physical properties, and maintains the smooth physical properties for an extended period of time without generating lumps over the course of multiple days, and thus the imitation cheese of the present invention is more preferably used as a substitute of cream cheese.

In addition, the imitation cheese of the present invention can be eaten as it is, and can be used as a raw material for food products including bakery products, confectionery, seasonings, or various dishes.

When the imitation cheese of the present invention is used as a raw material for food products, the form thereof is not particularly limited. For example, when the imitation cheese of the present invention is used as a raw material for bakery products, the imitation cheese can be used as a material kneaded or folded into a bread dough or a baked confectionery dough, a filling, a cream, a topping, an ingredient, or the like. When the imitation cheese is used as a raw material for confectionery, the imitation cheese can be used as a raw material for confectionery, a filling, a cream, a topping, or the like. When the imitation cheese is used as a raw material for seasonings, the imitation cheese can be used to be mixed in seasonings, or can be used to be mixed in vegetable, fruit, or nut or seed pieces, powder, or fruit juice. When the imitation cheese is used as a raw material of dishes, the imitation cheese can be used to be dressed or applied, or as a sauce, a topping, an ingredient, or the like.

A food product using the imitation cheese of the present invention is as described below.

### [Food Product Using Imitation Cheese of the Present Invention]

The food product of the present invention is produced using the imitation cheese of the present invention, and contains the imitation cheese of the present invention.

The food product of the present invention is not particularly limited as long as the imitation cheese of the present invention is used, but the food product of the present invention is preferably a food product particularly using a cream cheese, for example, a bakery product such as breads or baked confectionery, confectionery, seasonings, or dishes such as pizza, gratin, hamburg, or salad since the imitation cheese of the present invention has a cream cheese-like texture and smooth physical properties.

The food product of the present invention may be a food product in which the imitation cheese of the present invention is mixed with a food raw material such as finely cut vegetable or fruit, or fruit juice.

Examples of a bakery product, which is a preferable aspect of the food product of the present invention, include breads such as Pullman loaf, croissant, French loaf, Danish pastry, pie, brioche, English muffin, muffin, bagel, nan, corone (Japanese sweet bread), butter-enriched roll, curry bread, melon-shaped sweet bread, and cooked bread, and baked confectionery such as cookie, biscuit, waffle, doughnut, financier, madeleine, galette, tart, soufflé, bouchée, pound cake, pancake, baked cheesecake, no-baked cheesecake, roll cake, castella, tiramisu, burned cream, langue de chat, wafer, macaron, cream puff, cracker, dorayaki (Japanese confectionery), and steamed bun.

Examples of confectionery, which is a preferable aspect of the food product of the present invention, include pudding, jelly, chocolate, candy, caramel, senbei (Japanese confectionery), okaki (Japanese confectionery), dumpling, daifuku (Japanese confectionery), and iced confectionery such as ice cream.

Examples of a seasoning, which is a preferable aspect of the food product of the present invention, include dressing, mayonnaise, sauce, and dip. The seasoning may be a seasoning that is emulsified or is not emulsified. The form of the seasoning may be a liquid, a semisolid such as jelly or paste, a gel, or a solid obtained by freezing or the like.

Examples of a dish using the imitation cheese of the present invention include pizza, gratin, rice and cheese casserole, risotto, lasagna, hamburg, breaded pork cutlet, cheese fondu, and salad.

Aspects when the imitation cheese of the present invention is used for the food product of the present invention are as described above.

### EXAMPLES

Hereinafter, the present invention will be described in more detail with reference to Examples, but the present invention is not limited by these Examples in any way.

### [Production Example of Interesterified Fat and Oil]

### [Production of Interesterified Fat and Oil (1)]

A fat and oil blend consisting of 50% by mass of a palm kernel oil containing 50.1% by mass of a lauric acid residue in the constituent fatty acid residues (the same applies hereinafter to the palm kernel oil in the examples.) and 50% by mass of a fully hydrogenated palm oil was subjected to a random interesterification reaction using sodium methoxide as a catalyst. The resulting product was refined by a conventional method to obtain an interesterified fat and oil (1) that had a SUS content of 2.8% by mass in triglyceride composition. The interesterified fat and oil (1) corresponds to the fat and oil (A) described above.

### [Production of Interesterified Fat and Oil (2)]

A fat and oil blend consisting of 75% by mass of a palm kernel oil and 25% by mass of a fully hydrogenated palm oil was subjected to a random interesterification reaction using sodium methoxide as a catalyst. The resulting product was refined by a conventional method to obtain an interesterified fat and oil (2) that had a SUS content of 1.3% by mass in triglyceride composition. The interesterified fat and oil (2) corresponds to the fat and oil (A) described above.

### [Production of Interesterified Fat and Oil (3)]

A palm superolein having an iodine value of 64 in an amount of 100% by mass was subjected to a random interesterification reaction using sodium methoxide as a catalyst. The resulting product was refined by a conventional method to obtain an interesterified fat and oil (3) that had a SUS content of 8.5% by mass in triglyceride composition. The interesterified fat and oil (3) corresponds to the fat and oil (B) described above.

### [Non-Interesterified Fat and Oil Used]

Coconut Oil: The lauric acid residue content in the constituent fatty acid residues was 50.3% by mass and the SUS content in the triglyceride composition was 0% by mass. The coconut oil used in the present examples corresponds to the fat and oil (A) described above.

### [Plant-Derived Raw Material Used]

### [Almond-Derived Material (1)]

Dehulled and powdered almonds were used.

The protein content was 18.6% by mass, the amount of the fat and oil was 54.2% by mass, the carbohydrate content was 19.7% by mass, and the water content was 4.6% by mass (the amount of fat and oil relative to 1 part by mass of the protein content was 2.91 parts by mass). The almond-derived material (1) corresponds to the nut- and seed-derived material.

### [Almond-Derived Material (2)]

Dehulled almonds were defatted to concentrate the protein therein, and powdered for use.

The protein content was 44.4% by mass, the amount of the fat and oil was 11.8% by mass, the carbohydrate content was 32.8% by mass, and the water content was 5.0% by mass (the amount of fat and oil relative to 1 part by mass of the protein content was 0.27 part by mass). The almond-derived material (2) corresponds to the nut- and seed-derived material.

### [Soybean Powder]

Roasted powdered soybeans were used.

The protein content was 36.7% by mass, the amount of the fat and oil was 25.7% by mass, the carbohydrate content was 28.5% by mass, and the water content was 4.0% by mass (the amount of fat and oil relative to 1 part by mass of the protein content was 0.70 part by mass).

### [Soybean Protein]

Separated soybean protein powder was used.

The protein content was 80.7% by mass, the amount of the fat and oil was 3.0% by mass, the carbohydrate content was 7.7% by mass, and the water content was 6.0% by mass (the amount of fat and oil relative to 1 part by mass of the protein content was 0.04 part by mass).

### [Chickpea Powder]

Chickpea heated by steam and powdered was used.

The protein content was 20.0% by mass, the amount of the fat and oil was 7.0% by mass, the carbohydrate content was 65.0% by mass, and the water content was 5.0% by mass (the amount of fat and oil relative to 1 part by mass of the protein content was 0.35 part by mass).

### [Almond Milk]

“Rich Almond Milk—Moderate Plain—” (manufactured by Tsukuba Dairy Products Co., Ltd.) was used.

The protein content was 2.7% by mass, the amount of the fat and oil was 5.4% by mass, the carbohydrate content was 1.1% by mass, and the water content was 90.8% by mass (the amount of fat and oil relative to 1 part by mass of the protein content was 2.00 parts by mass).

### [Aging-Resistant Starch Used]

### [Aging-Resistant Starch (1)]

A hydroxypropylated phosphoric acid-crosslinked starch produced from a corn-derived raw starch having an amylose content of 25% by mass.

The aging-resistant starch (1) corresponds to the aging-resistant starch (α) described above.

### [Aging-Resistant Starch (2)]

A hydroxypropylated phosphoric acid-crosslinked starch produced from a waxy corn-derived raw material starch having an amylose content of 0% by mass.

The aging-resistant starch (2) corresponds to the aging-resistant starch (β) described above.

### <Study 1>

Plant-derived raw materials used for imitation cheeses were studied.

### <<Production of Imitation Cheese>>

Imitation cheeses of Examples 1-1 to 1-2 and Comparative Examples 1-1 to 1-5 were produced in accordance with the blends in Table 1 by the following procedure.

### [Production Procedure]

Any one type of the almond-derived material (1), the almond-derived material (2), the soybean powder, the soybean protein, and the chickpea powder, and a thickening stabilizer were added to mixed fats and oils that were heated and dissolved, and were stirred and mixed to obtain an oil phase.

Subsequently, the aging-resistant starch (1) and the aging-resistant starch (2), trehalose, common salt, and almond milk for Comparative Examples 1~4 and Comparative Examples 1-5 were added to water and stirred and mixed to obtain an aqueous phase.

The oil phase was added to the aqueous phase and mixed to obtain an oil-in-water preliminary emulsion.

To the obtained preliminary emulsion, 50% fermented lactic acid (fermented lactic acid containing 50% lactic acid) was added so that its pH was adjusted to the pH value shown in Table 1, followed by homogenization at a homogenization pressure of 15 MPa to obtain an oil-in-water emulsion composition.

The resulting oil-in-water emulsion composition was heated in a direct heating-type UHT sterilizer at 120° C. for 3 seconds, and then cooled slowly to 4° C. to obtain an imitation cheese of each of Examples 1-1 to 1-2 and Comparative Examples 1-1 to 1-5.

TABLE 1

| | Example | Example | Comparative | Comparative | Comparative | Comparative | Comparative |
|---|---|---|---|---|---|---|---|
| (% by mass) | 1-1 | 1-2 | Example 1-1 | Example 1-2 | Example 1-3 | Example 1-4 | Example 1-5 |
| Interesterified fat and oil (1) | 3 | 3 | 3 | 3 | 3 | 3 | 3 |
| Coconut oil | 17 | 17 | 17 | 17 | 17 | 17 | 17 |
| Almond-derived material (1) | 4 | | | | | | |
| Almond-derived material (2) | | 2 | | | | | |
| Soybean powder | | | 4 | | | | |
| Soybean protein | | | | 4 | | | |
| Chickpea powder | | | | | 4 | | |
| Almond milk | | | | | | 4 | 33 |
| Aging-resistant starch (1) | 4 | 4 | 4 | 4 | 4 | 4 | 4 |
| Aging-resistant starch (2) | 2 | 2 | 2 | 2 | 2 | 2 | 2 |
| Trehalose | 10 | 10 | 10 | 10 | 10 | 10 | 10 |
| Common salt | 1 | 1 | 1 | 1 | 1 | 1 | 1 |
| Thickening stabilizer | 0.2 | 0.2 | 0.2 | 0.2 | 0.2 | 0.2 | 0.2 |
| 50% fermented lactic acid | 0.3 | 0.3 | 0.4 | 0.6 | 0.3 | 0.1 | 0.3 |
| Water | 58.5 | 60.5 | 58.4 | 58.2 | 58.5 | 58.7 | 29.5 |
| pH | 4.1 | 4.1 | 4.1 | 4.1 | 4.1 | 4.1 | 4.1 |
| Fat and oil amount in oil-in- | 22.2 | 20.2 | 21.0 | 20.1 | 20.3 | 20.2 | 21.8 |
| water emulsion composition * ¹ | | | | | | | |
| Water amount in oil-in-water | 59.6 | 61.5 | 59.5 | 59.5 | 59.6 | 63.1 | 60.4 |
| emulsion composition * ¹ | | | | | | | |
| SFC at 35° C. of oil phase (%) | 4.8 | 4.8 | 4.8 | 4.8 | 4.8 | 4.8 | 4.8 |
| SUS content * ¹ * ² | 0.4 | 0.4 | 0.4 | 0.4 | 0.4 | 0.4 | 0.4 |
| Protein content in imitation cheese * ¹ | 0.7 | 0.9 | 1.5 | 3.2 | 0.8 | 0.1 | 0.9 |

* ¹ Unit is % by mass
* ² Proportion of SUS in triglyceride composition in fat and oil

### <<Imitation Cheese Evaluation 1>>

The imitation cheeses of Examples 1-1 to 1-2 and Comparative Examples 1-1 to 1-5 were subjected to the following respective evaluations. The evaluation results are shown in Table 2. In Examples, an imitation cheese that obtained an evaluation equal to or more than + in all evaluation criteria was considered to be an acceptable product.

### [Emulsion Stability Evaluation]

The imitation cheeses immediately after the production were visually observed, and emulsion stability was evaluated in accordance with the following evaluation criteria.

### (Emulsion Stability Evaluation Criteria)+

+: The emulsion stability was good, and oil-water separation was hardly seen.
−: The emulsion stability was somewhat poor, and some oil-water separation was seen.
−−: The emulsion stability was poor, and oil-water separation was severe.

### [Evaluation of Taste and Texture]

An imitation cheese that obtained an evaluation of + or − in the emulsion stability evaluation was stored at 4° C. for 7 days after the production. Five expert panelists ate the imitation cheese and Kraft Philadelphia Cream Cheese (manufactured by Morinaga Milk Industry Co., Ltd.) as a control, and graded the taste and texture of each of the cheeses in accordance with the following respective evaluation criteria. Prior to the evaluation, the panelists fitted the degree of senses corresponding to each of scores.

Evaluation results in Table 2 are shown by the following expression method depending on the total score of evaluation scores (0 to 3 points) of the respective panelists.

### (Expression Method)

13 to 15 points: ++
10 to 12 points: +
6 to 9 points: −
0 to 5 points: −−

### (Taste Evaluation Criteria)

3 points: No odd taste was perceived, and the taste was very close to the cream cheese as the control and excellent.
2 points: An odd taste was slightly perceived, but was acceptable. The taste was close to the cream cheese as the control and favorable.
1 point: An odd taste was slightly perceived. The taste was somewhat poor.
0 point: An odd taste was strongly perceived. The taste was very poor.

### (Texture Evaluation)

3 points: A rough texture was completely not present, and the texture was very close to the cream cheese as the control and excellent.
2 points: A rough texture was slightly felt, but was acceptable. The texture was close to the cream cheese as the control and favorable.
1 point: A rough texture was somewhat felt. The texture was not close to the cream cheese as the control and somewhat poor.
0 point: A rough texture was strongly felt. The texture was completely different from the cream cheese as the control and poor.

### [Evaluation of Physical Properties Over Days]

The imitation cheese that obtained the evaluation criterion + or − in stability evaluation was stored at 4° C. for 30 days and 60 days after the production. The physical properties of the imitation cheese when about 15 g of the imitation cheese after the storage was applied to pullman loaf with a butter knife were compared with the physical properties when Kraft Philadelphia Cream Cheese (manufactured by Morinaga Milk Industry Co., Ltd.) was applied to pullman loaf in the same manner, and evaluated by visual observation in accordance with the following evaluation criteria.

### (Evaluation Criteria of Physical Properties)

++: The generation of lumps over the course of multiple days was not completely seen. The physical properties were very close to the cream cheese as the control and very smooth.
+: The generation of lumps over the course of multiple days was slightly seen, but was acceptable. The physical properties were close to the cream cheese as the control and smooth.
−: Lumps were somewhat generated. The physical properties were different from the cream cheese as the control, and smooth physical properties were somewhat lost.
−−: Many lumps were generated. The physical properties were completely different from the cream cheese as the control, and smooth physical properties were lost.

TABLE 2

| | Example | Example | Comparative | Comparative | Comparative | Comparative | Comparative |
|---|---|---|---|---|---|---|---|
| | 1-1 | 1-2 | Example 1-1 | Example 1-2 | Example 1-3 | Example 1-4 | Example 1-5 |
| Emulsion stability | + | + | − − | − | + | − − | + |
| Taste | + | ++ | | − − | + | | − |
| Texture | ++ | ++ | | − − | ++ | | ++ |
| Physical properties | ++ | ++ | | + | − | | ++ |
| 30 days after production | | | | | | | |
| Physical properties | + | ++ | | − | − | | ++ |
| 60 days after production | | | | | | | |

In the imitation cheeses of the present invention of Examples 1-1 and 1-2 using as the plant-derived raw material only the almond-derived material (1) and the almond-derived material (2), respectively, which were the nut- and seed-derived material, any odd taste therefrom was not perceived. The imitation cheeses had a favorable cream cheese-like taste and a favorable texture without a rough texture, and the emulsion stability was also good. Even 60 days after the production, lumps were not generated, and cream cheese-like smooth physical properties were maintained.

In particular, the imitation cheese of the present invention of Example 1-2 using the almond-derived material (2) having a high protein content and a low lipid content had a favorable taste closer to a cream cheese and achieved smoother physical properties 60 days after the production than the imitation cheese of the present invention of Example 1-1.

In contrast, in Comparative Example 1-1 using only a soybean powder as the plant-derived raw material, the emulsion stability was poor immediately after the heating step in the production process, and oil-water separation severely occurred in the resultant imitation cheese.

In the imitation cheese of Comparative Example 1-2 using only a soybean protein, oil-water separation also somewhat occurred. A soybean-specific odd taste was perceived, the texture was rough, and the imitation cheese was completely different from a cream cheese and poor. In addition, 30 days after the production, lumps were not seen, and the physical properties were good, but 60 days after the production, lumps were slightly seen, and smooth physical properties were somewhat lost.

In the imitation cheese of Comparative Example 1-3 using only a chick pea powder, an odd taste was slightly perceived, but was acceptable, and the taste and the texture were close to a cream cheese and favorable, as compared with the imitation cheese of Comparative Example 1-2. However, at a time of 30 days after the production, lumps were confirmed in the imitation cheese, and 60 days after the production, lumps were further increased, and smooth physical properties were lost.

In the imitation cheese of Comparative Example 1-4 using only almond milk, which was the nut- and seed-derived material having a protein content of less than 15% by mass, the emulsion stability was very poor and oil-water separation was severe due to a low protein content in the imitation cheese. In the imitation cheese of Comparative Example 1-5 in which the amount of blended almond milk was increased, oil-water separation was suppressed as compared with Comparative Example 1-4, but due to an increase in blending amount of almond milk, an odd taste was perceived and the taste was poor.

Therefore, when only the nut- and seed-derived material having a protein content of less than 15% by mass is used, the blending amount needs to be increased to suppress oil-water separation, and an odd taste is generated. This shows that the effects of the present invention are not obtained.

As seen from the results of Study 1, the use of the nut- and seed-derived material can obtain the imitation cheese that can solve the problems of the present invention. In particular, the use of the nut- and seed-derived material having a high protein content and a low lipid content can more preferably achieve the effects of the present invention.

### <Study 2>

The content of the nut- and seed-derived material used for an imitation cheese was studied.

Imitation cheeses of Examples 2-1 to 2-2 and Comparative Example 2-1 were produced by the same production procedure as described above except that the blend shown in Table 1 was changed to the blend shown in Table 3.

TABLE 3

| | Comparative | Example | (Reference) | Example |
|---|---|---|---|---|
| (% by mass) | Example 2-1 | 2-1 | Example 1-2 | 2-2 |
| Interesterified fat | 3 | 3 | 3 | 3 |
| and oil (1) | | | | |
| Coconut oil | 17 | 17 | 17 | 17 |
| Almond-derived material (2) | | 1 | 2 | 4 |
| Aging-resistant starch (1) | 4 | 4 | 4 | 4 |
| Aging-resistant starch (2) | 2 | 2 | 2 | 2 |
| Trehalose | 10 | 10 | 10 | 10 |
| Common salt | 1 | 1 | 1 | 1 |
| Thickening stabilizer | 0.2 | 0.2 | 0.2 | 0.2 |
| 50% fermented lactic acid | 0.1 | 0.2 | 0.3 | 0.4 |
| Water | 62.7 | 61.6 | 60.5 | 58.4 |
| pH | 4.1 | 4.1 | 4.1 | 4.1 |
| Fat and oil amount in oil-in- | 20.0 | 20.1 | 20.2 | 20.5 |
| water emulsion composition * ¹ | | | | |
| Water amount in oil-in-water | 63.5 | 62.5 | 61.5 | 59.6 |
| emulsion composition * ¹ | | | | |
| SFC at 35° C. of oil phase (%) | 4.8 | 4.8 | 4.8 | 4.8 |
| SUS content * ¹ * ² | 0.4 | 0.4 | 0.4 | 0.4 |
| Protein content in | 0 | 0.4 | 0.9 | 1.8 |
| imitation cheese * ¹ | | | | |

* ¹ Unit is % by mass
* ² Proportion of SUS in triglyceride composition in fat and oil

### <<<<Imitation Cheese Evaluation 2>>

The emulsion stability, taste, texture, and daily physical properties of the imitation cheese in each of Examples 2-1 to 2-2 and Comparative Example 2-1 were evaluated by the same method in accordance with the same evaluation criteria as in Imitation cheese evaluation 1. The evaluation results are shown in Table 4.

TABLE 4

| | Comparative | Example | (Reference) | Example |
|---|---|---|---|---|
| | Example 2-1 | 2-1 | Example 1-2 | 2-2 |
| Emulsion stability | − − | + | + | + |
| Taste | | ++ | ++ | + |
| Texture | | ++ | ++ | + |
| Physical properties | | ++ | ++ | ++ |
| 30 days after | | | | |
| production | | | | |
| Physical properties | | ++ | ++ | + |
| 60 days after | | | | |
| production | | | | |

As seen from the results of Examples 2-1 to 2-2 and 1-2, even when the content of the nut- and seed-derived material is changed, the imitation cheese that can solve the problems of the present invention is obtained. In the imitation cheese of the present invention of Example 2-2 in which the content of the nut- and seed-derived material is high among these, an odd taste and a rough texture were slightly perceived, but were acceptable. Although 60 days after the production, lumps were slightly seen, the physical properties were also acceptable.

In contrast, in Comparative Example 2-1 in which production was performed without adding the nut- and seed-derived material, the emulsion stability was poor, and oil-water separation was severe. Accordingly, it is found that the use of the nut- and seed-derived material is necessary to achieve the effects of the present invention.

### <Study 3>

The aging-resistant starch used for an imitation cheese was studied.

Imitation cheeses of Examples 3-1 to 3-2 and Comparative Example 3-1 were produced by the same production procedure as described above except that the blend shown in Table 1 was changed to the blend shown in Table 5.

TABLE 5

| | Example | (Reference) | Example | Comparative |
|---|---|---|---|---|
| (% by mass) | 3-1 | Example 1-2 | 3-2 | Example 3-1 |
| Interesterified fat | 3 | 3 | 3 | 3 |
| and oil (1) | | | | |
| Coconut oil | 17 | 17 | 17 | 17 |
| Almond-derived material (2) | 2 | 2 | 2 | 2 |
| Aging-resistant starch (1) | 1.5 | 4 | 6 | |
| Aging-resistant starch (2) | 1 | 2 | 3 | |
| Corn-derived raw material | | | | 6 |
| starch | | | | |
| Trehalose | 10 | 10 | 10 | 10 |
| Common salt | 1 | 1 | 1 | 1 |
| Thickening stabilizer | 0.2 | 0.2 | 0.2 | 0.2 |
| 50% fermented lactic acid | 0.3 | 0.3 | 0.3 | 0.3 |
| Water | 64 | 60.5 | 57.5 | 60.5 |
| pH | 4.1 | 4.1 | 4.1 | 4.1 |
| Fat and oil amount in oil-in- | 20.2 | 20.2 | 20.2 | 20.2 |
| water emulsion composition * ¹ | | | | |
| Water amount in oil-in-water | 64.6 | 61.5 | 58.9 | 61.5 |
| emulsion composition * ¹ | | | | |
| SFC at 35° C. of oil phase (%) | 4.8 | 4.8 | 4.8 | 4.8 |
| SUS content * ¹ * ² | 0.4 | 0.4 | 0.4 | 0.4 |
| Protein content in | 0.9 | 0.9 | 0.9 | 0.9 |
| imitation cheese * ¹ | | | | |

* ¹ Unit is % by mass
* ² Proportion of SUS in triglyceride composition in fat and oil

### <<Imitation Cheese Evaluation 3>>

The emulsion stability, taste, texture, and daily physical properties of the imitation cheese in each of Examples 3-1 to 3-2 and Comparative Example 3-1 were evaluated by the same method in accordance with the same evaluation criteria as in Imitation cheese evaluation 1. The evaluation results are shown in Table 6.

TABLE 6

| | Example | (Reference) | Example | Comparative |
|---|---|---|---|---|
| | 3-1 | Example 1-2 | 3-2 | Example 3-1 |
| Emulsion stability | + | + | + | + |
| Taste | ++ | ++ | ++ | ++ |
| Texture | + | ++ | ++ | ++ |
| Physical properties | ++ | ++ | ++ | − − |
| 30 days after | | | | |
| production | | | | |
| Physical properties | ++ | ++ | + | − − |
| 60 days after | | | | |
| production | | | | |

As seen from the results of Examples 3-1 to 3-2 and 1-2, even when the content of the aging-resistant starch is changed, the imitation cheese that can solve the problems of the present invention is obtained. In particular, the imitation cheese of the present invention of Example 1-2 had a texture and smooth physical properties closer to a cream cheese.

In the imitation cheese of the present invention of Example 3-1 in which the content of the aging-resistant starch was low, smoothness was less than the imitation cheese of the present invention of Example 1-2 and a rough texture was slightly felt, but they were acceptable. In the imitation cheese of the present invention of Example 3-2 in which the content of the aging-resistant starch was high, lumps were slightly seen 60 days after the production, but were acceptable.

In contrast, in the imitation cheese of Comparative Example 3-1 using the corn-derived raw material starch instead of the aging-resistant starch, oil-water separation was not seen, an odd taste was not perceived, and the texture was also close to a cream cheese and favorable, but many lumps that appeared to be caused by a starch were formed over the course of multiple days, and smooth physical properties were lost.

As seen from the results of Study 3, the use of the aging-resistant starch is necessary to achieve the effects of the present invention.

### <Study 4>

The pH of the oil-in-water emulsion composition was studied.

Imitation cheeses of Examples 4-1 to 4-2 were produced by the same production procedure as described above except that the blend shown in Table 1 was changed to the blend shown in Table 7.

TABLE 7

| | | (Reference) | |
|---|---|---|---|
| (% by mass) | Example4-1 | Example1-2 | Example4-2 |
| Interesterified fat and oil (1) | 3 | 3 | 3 |
| Coconut oil | 17 | 17 | 17 |
| Almond-derived material (2) | 2 | 2 | 2 |
| Aging-resistant starch (1) | 4 | 4 | 4 |
| Aging-resistant starch (2) | 2 | 2 | 2 |
| Trehalose | 10 | 10 | 10 |
| Common salt | 1 | 1 | 1 |
| Thickening stabilizer | 0.2 | 0.2 | 0.2 |
| 50% fermented lactic acid | 0.7 | 0.3 | 0.1 |
| Water | 60.1 | 60.5 | 60.7 |
| pH | 3.8 | 4.1 | 5.4 |
| Fat and oil amount in oil-in- | 20.2 | 20.2 | 20.2 |
| water emulsion | | | |
| composition * ¹ | | | |
| Water amount in oil-in-water | 61.3 | 61.5 | 61.6 |
| emulsion composition * ¹ | | | |
| SFC at 35° C. of oil | 4.8 | 4.8 | 4.8 |
| phase (%) | | | |
| SUS content * ¹ * ² | 0.4 | 0.4 | 0.4 |
| Protein content in | 0.9 | 0.9 | 0.9 |
| imitation cheese * ¹ | | | |

* ¹ Unit is % by mass
* ² Proportion of SUS in triglyceride composition in fat and oil

### <<<<Imitation Cheese Evaluation 4>>

The emulsion stability, taste, texture, and daily physical properties of the imitation cheese in each of Examples 4-1 to 4-2 were evaluated by the same method in accordance with the same evaluation criteria as in Imitation cheese evaluation 1. The evaluation results are shown in Table 8.

TABLE 8

| | | (Reference) | |
|---|---|---|---|
| | Example 4-1 | Example 1-2 | Example 4-2 |
| Emulsion stability | + | + | + |
| Taste | ++ | ++ | + |
| Texture | ++ | ++ | ++ |
| Physical properties | ++ | ++ | ++ |
| 30 days after production | | | |
| Physical properties | ++ | ++ | ++ |
| 60 days after production | | | |

The imitation cheeses of the present invention of Examples 4-1 to 4-2 and 1-2 in which the pH of the oil-in-water emulsion composition was adjusted to 3.5 to 6.0 were able to achieve the effects of the present invention. Among these, the imitation cheeses of the present invention of Example 4-1 and Example 1-2 in which the pH was adjusted to a lower pH had a favorable taste having sour taste closer to a cream cheese while the emulsion stability was good, as compared with the imitation cheese of the present invention of Example 4-2.

### <Study 5>

The fat and oil blend of an imitation cheese was studied.

Imitation cheeses of Examples 5-1 to 5-3 were produced by the same production procedure as described above except that the blend shown in Table 1 was changed to the blend shown in Table 9.

TABLE 9

| | (Reference) | Example | Example | Example |
|---|---|---|---|---|
| (% by mass) | Example 1-2 | 5-1 | 5-2 | 5-3 |
| Interesterified fat and oil (1) | 3 | 2.5 | | |
| Interesterified fat and oil (2) | | 22.5 | | |
| Interesterified fat and oil (3) | | | 25 | |
| Coconut oil | 17 | | | 20 |
| Almond-derived material (2) | 2 | 2 | 2 | 2 |
| Aging-resistant starch (1) | 4 | 4 | 4 | 4 |
| Aging-resistant starch (2) | 2 | 2 | 2 | 2 |
| Trehalose | 10 | 10 | 10 | 10 |
| Common salt | 1 | 1 | 1 | 1 |
| Thickening stabilize | 0.2 | 0.2 | 0.2 | 0.2 |
| 50% fermented lactic acid | 0.3 | 0.3 | 0.3 | 0.3 |
| Water | 60.5 | 55.5 | 55.5 | 60.5 |
| pH | 4.1 | 4.1 | 4.1 | 4.1 |
| Fat and oil amount in oil-in- | 20.2 | 25.2 | 25.2 | 20.2 |
| water emulsion composition * ¹ | | | | |
| Water amount in oil-in-water | 61.5 | 56.5 | 56.5 | 61.5 |
| emulsion composition * ¹ | | | | |
| SFC at 35° C. of oil phase (%) | 4.8 | 5.3 | 3.0 | 0.1 |
| SUS content * ¹ * ² | 0.4 | 1.5 | 8.5 | 0 |
| Protein content in | 0.9 | 0.9 | 0.9 | 0.9 |
| imitation cheese * ¹ | | | | |

* ¹ Unit is % by mass
* ² Proportion of SUS in triglyceride composition in fat and oil

### <<Imitation Cheese Evaluation 5>>

The emulsion stability, taste, texture, and daily physical properties of the imitation cheese in each of Examples 5-1 to 5-3 were evaluated by the same method in accordance with the same evaluation criteria as in Imitation cheese evaluation 1. The evaluation results are shown in Table 10.

TABLE 10

| | (Reference) | Example | Example | Example |
|---|---|---|---|---|
| | Example 1-2 | 5-1 | 5-2 | 5-3 |
| Emulsion stability | + | + | + | + |
| Taste | ++ | ++ | ++ | ++ |
| Texture | ++ | ++ | ++ | + |
| Physical properties | ++ | ++ | + | ++ |
| 30 days after | | | | |
| production | | | | |
| Physical properties | ++ | + | + | ++ |
| 60 days after | | | | |
| production | | | | |

The imitation cheeses of the present invention of Examples 5-1, 5-3, and 1-2 in which the fat and oil (A) was contained, and the imitation cheese of the present invention in Example 5-2 in which the fat and oil (B) was contained can satisfactorily achieve the effects of the present invention.

In particular, in the imitation cheeses of the present invention of Examples 5-1, 5-3, and 1-2 in which the SUS content in the triglyceride composition of the fat and oil contained in the imitation cheeses was low, lumps were not formed even after the elapse of 60 days, and smooth physical properties could be further maintained, as compared with Example 5-2.

Furthermore, in comparison between the imitation cheeses of the present invention of Examples 5-1, 5-3, and 1-2, the imitation cheeses could achieve the effects of the present invention. In particular, the imitation cheeses of the present invention of Examples 5-3 and 1-2 in which coconut oil was used had smoother physical properties 60 days after the production. In addition, the imitation cheeses had a favorable soft texture and a more cream cheese-like texture.

In comparison between Examples 5-3 and 1-2, the imitation cheese of Example 1-2 in which coconut oil as a non-interesterified fat and oil, and an interesterified fat and oil of a fat and oil blend containing a palm kernel oil were used in combination had a more smooth texture without a rough texture.

### <Study 6>

As the food product using the imitation cheese, a baked cheesecake was produced and studied.

### <<Production of Baked Cheesecake>>

A baked cheesecake containing the imitation cheese or cream cheese was produced using the imitation cheese of each of Examples 1-2, 5-1, 5-2, and 5-3, and Comparative Example 1-2 or Kraft Philadelphia Cream Cheese (manufactured by Morinaga Milk Industry Co., Ltd.) as a control by the following method in accordance with the following blend.

### [Blend of Baked Cheesecake]

Margarine: 100 parts by mass
Biscuit: 230 parts by mass
Imitation cheese or Kraft Philadelphia Cream Cheese: 250 parts by mass
Super fine sugar: 60 parts by mass
Lemon juice: 8 parts by mass
Soft wheat flour: 25 parts by mass
Soybean milk: 100 parts by mass

### [Method for Production Baked Cheesecake]

Biscuit was finely crushed, and melted margarine was added thereto and thoroughly mixed to obtain a base crust. Fifty grams of the base crust was laid in a circular pan so as to be flat.

The imitation cheese or Kraft Philadelphia Cream Cheese returned to room temperature was thoroughly kneaded with a spatula or the like. Superfine sugar, lemon juice, sieved soft wheat flour, and soybean milk were added to the kneaded cheese in order, and the mixture was thoroughly mixed with a foaming machine each time to obtain a cheese dough. After mixing, 400 g of the cheese dough was poured into the base crust and baked in an oven heated to 180° C. for 35 minutes to obtain each baked cheesecake.

### <<Baked Cheesecake Evaluation>>

The baked cheesecakes produced using the respective imitation cheeses of Examples 1-2, 5-1, 5-2, and 5-3, which were the imitation cheese of the present invention, had a favorable appearance and a smooth texture, and an odd taste was not perceived. The baked cheesecakes were comparable to the baked cheesecake produced using Kraft Philadelphia Cream Cheese as the control.

In contrast, the baked cheesecake produced using the imitation cheese of Comparative Example 1-2 containing a soybean protein caused oil-water separation during baking, had a poor appearance, and smoothness was also lost due to poor emulsification of the used imitation cheese. In addition, an odd taste was perceived.

Accordingly, it is found that the food product using the imitation cheese of the present invention is comparable to a food product using a general cream cheese and the imitation cheese of the present invention can be preferably used as a substitute of the general cream cheese.

1. An imitation cheese comprising an oil-in-water emulsion composition containing a nut- and seed-derived material and an aging-resistant starch, the nut- and seed-derived material having a protein content of 15 to 95% by mass, the oil-in-water emulsion composition having a pH of 3.5 to 6.0, and the imitation cheese having a protein content of 0.2 to 10.0% by mass.

2. The imitation cheese according to claim 1, wherein an amount of fat and oil of the nut- and seed-derived material is 40% by mass or less.

3. The imitation cheese according to claim 1, wherein an amount of fat and oil of the nut- and seed-derived material is 2.0 parts by mass or less relative to 1 part by mass of the protein content of the nut- and seed-derived material.

4. The imitation cheese according to claim 1, wherein the nut- and seed-derived material is contained in an amount of 0.1 to 10% by mass in the oil-in-water emulsion composition.

5. The imitation cheese according to claim 3, wherein the nut- and seed-derived material is contained in an amount of 0.1 to 10% by mass in the oil-in-water emulsion composition.

6. The imitation cheese according to claim 1, wherein the aging-resistant starch contains a processed starch that has been subjected to a hydroxypropylation treatment.

7. The imitation cheese according to claim 3, wherein the aging-resistant starch contains a processed starch that has been subjected to a hydroxypropylation treatment.

8. The imitation cheese according to claim 1, wherein a proportion of SUS in a triglyceride composition in a fat and oil included in the oil-in-water emulsion composition is 15% by mass or less,
provided that S represents a saturated fatty acid residue of 16 to 18 carbon atoms, U represents an unsaturated fatty acid residue of 16 to 18 carbon atoms, and SUS represents a triglyceride in which one molecule of S is bonded to each of positions 1 and 3 of a glycerin residue in one molecule, and one molecule of U is bonded to position 2.

9. A method for producing an imitation cheese, the imitation cheese including an oil-in-water emulsion composition containing a nut- and seed-derived material and an aging-resistant starch, the nut- and seed-derived material having a protein content of 15 to 95% by mass, the oil-in-water emulsion composition having a pH of 3.5 to 6.0, the imitation cheese having a protein content of 0.2 to 10.0% by mass, the method for producing an imitation cheese comprising the following (Step 1) to (Step 5):
(Step 1) a step of preparing a preliminary emulsion containing the nut- and seed-derived material, which has a protein content of 15 to 95% by mass, and the aging-resistant starch;
(Step 2) a step of adjusting a pH of the preliminary emulsion to 3.5 to 6.0;
(Step 3) a step of homogenizing the preliminary emulsion to obtain an oil-in-water emulsion composition;
(Step 4) a step of heating the oil-in-water emulsion composition, which is obtained by homogenization, to be at least 80° C. or higher; and
(Step 5) a step of cooling the oil-in-water emulsion composition, which has been heated to be at least 80° C. or higher, to be at least 20° C. or lower.

10. A food product comprising an imitation cheese including an oil-in-water emulsion composition containing a nut- and seed-derived material and an aging-resistant starch, the nut- and seed-derived material having a protein content of 15 to 95% by mass, the oil-in-water emulsion composition having a pH of 3.5 to 6.0, and the imitation cheese having a protein content of 0.2 to 10.0% by mass.
